(19) United States
(12) Patent Application Publication
(10) Pub. No.: US 2017/0337354 A1
(43) Pub. Date: Nov. 23, 2017

(54) Method of Governing Content Presentation and the Altering of Multi-Page Electronic Documents

(71) Applicant: Leonard L. Drey, St. Louis, MO (US)

(72) Inventor: Leonard L. Drey, St. Louis, MO (US)

(21) Appl. No.: 15/600,501

(22) Filed: May 19, 2017

Related U.S. Application Data
(60) Provisional application No. 62/338,816, filed on May 19, 2016.
(60) Provisional application No. 62/428,673, filed on Dec. 1, 2016.
(60) Provisional application No. 62/439,217, filed on Dec. 27, 2016.

(51) Int. Cl. G06F 21/10; G06Q 50/18; G06F 3/0483; G06F 17/21; H04L 29/06; G06F 17/22; G06Q 20/14

(52) U.S. Cl. CPC G06F 21/10; H04L 63/06; G06Q 50/184; G06F 17/2288; G06F 3/0483; G06F 17/2247; G06F 17/2229; G06F 17/218; G06Q 20/145

(57) ABSTRACT

A method of governing presentation of electronic documents includes providing a document file. The document file includes a program file and an associated text file. The text file is provided to an author, who creates a current version of a work of content, which is parsed into defined units of content. The author provides the current version to a user in a sequence determined by the author. The work of content is arranged such that a predefined action and/or condition causes redirection of the viewing of the content from a current unit to a different unit, regardless of the sequence; revealing to the user previously unviewable units and/or concealing a currently viewable unit; addition of a subsequent unit and/or removal of a current unit; replacement of a current unit by a subsequent unit; and/or replacement of the current version with a subsequent version.

### CROSS-REFERENCE TO RELATED APPLICATIONS

This is a continuation-in-part of U.S. patent application Ser. No. 14/965,855, which is related to, and claims priority from, U.S. Provisional application for Patent No. 62/090,095, which was filed on Dec. 10, 2014, and U.S. Provisional application for Patent No. 62/211,112, which was filed on Aug. 28, 2015; which in turn is a continuation-in-part of U.S. patent application Ser. No. 14/524,694, which was filed on Oct. 27, 2014, which is related to, and claims priority from, U.S. Provisional application for Patent No. 61/895,654, which was filed on Oct. 25, 2013, U.S. Provisional application for Patent No. 61/904,252, which was filed on Nov. 14, 2013, and U.S. Provisional application for Patent No. 61/908,383, which was filed on Nov. 25, 2013; and is related to, and claims priority from, U.S. Provisional application for Patent No. 62/338,816, which was filed on May 19, 2016, U.S. Provisional application for Patent No. 62/428,673, which was filed on Dec. 1, 2016, and U.S. Provisional application for Patent No. 62/439,217, which was filed on Dec. 27, 2016; the disclosures of all of which are incorporated herein in their entireties.

### FIELD OF THE INVENTION

The invention relates to methods of presenting content to a viewer, for example, on a computer display or a dedicated electronic display device. In particular, the invention relates to a means of control over the timing and manner of presentation of multiple pages or other discrete units of content.

### BACKGROUND OF THE INVENTION

For the most part when conventional works are published on paper, their content has to be presented in linear form. In addition, on completion of a manuscript or other content the author's thought process has to be “arrested” at some fundamentally arbitrary point. Alternative attempts to explain or justify an idea cannot be made by the author except through making the text cluttered and harder to read. And content once published cannot be modified unless a new version is brought out by the publisher.

Therefore, enormous effort is typically expended by published authors to produce a “single best version” of a work that can be understood by the greatest number of the intended audience. Outlines may be conceived of in advance, and word choice and grammar and style may be tended to with exceptional care because such authors know that they will have only one constrained opportunity to make their meaning known.

Looked at from the opposite perspective—if a reader wants to understand some published object of content better, there is little that he or she can do other than to re-read the same material again, ideally while taking notes, or underlining or highlighting.

Content provided to a viewer on a computer has the potential to overcome these limitations, yet this capability is underutilized. A need exists to enhance the capability of electronic media so that content can be provided in ways that will transcend the limitations of static linear expression.

The concept that there could be, within a published work, commenting pages “hidden” between original pages of text, viewable by a reader only after he or she had read some pages further into the document, is a notion that was so unsuited to—so unsound in—the old world of paper publishing that probably in the technology's first five and a half centuries, it had never been considered despite the usefulness of the approach.

Recently the capacity for Web-based books and articles to be published in various formats has been proffered by electronic publishers. However, a limitation shared by all pertains to the publisher's inability to limit dissemination of a document after the sale. Electronic books and articles published online can costlessly be multiplied by buyers quite easily through emailing links to friends and other contacts—even to the extent that some Web publishers do not caution against the practice.

In a similar way problems are faced especially by corporations and governmental organizations stemming from the evident impossibility of preventing confidential documents—even millions at once—from being surreptitiously copied onto small electronic storage devices by individuals who have had access to these legally at the time but now wish to disseminate them illegitimately. It would be ideal if for instance electronic documents that were meant to be circulated to members of a carefully selected “core group” reading list could be copied only onto one electronic storage device, and then locked onto that permanently, and/or never allowed to be duplicated.

Similarly, there may be times when an author or publisher would wish it if certain individuals—underinformed but at the same time let us say vain—who have neither the training nor the temperament to comprehend the work at hand, yet would assume that they did while reading it—could be prevented from being able to access the document easily, or perhaps before satisfying certain conditions.

Further, sometimes a publisher or an author might like it if a document when being made available online could be made non-searchable by conventional search engines.

No means has existed to satisfy these needs, till now.

### BRIEF SUMMARY OF THE INVENTION

By using the present invention, to a large extent an author can prevent potential readers whom he or she would want not to read a work from reading it. As a non-limiting example, if an author has written something that he feels is excessively personal or that he feels the average reader because of a lack of training or lack of exposure to relevant life experiences could not understand, no matter what he or she might think while reading it, that author can limit dissemination by preparing an “acceptables” list of email addresses against which requests for the work would be matched by the publisher's server before being fulfilled.

Through use of the invention, authors will not be able to block everyone whom they did not wish to read a work from getting their hands on it, of course; copies could be borrowed or stolen. But in the author's eyes “the wrong people” will at least not be able to go to the store and buy a copy, click on a link, or have the work drop into their inbox as an unsolicited attachment.

Where the invention is in use as a means of limiting the dissemination of sensitive materials, as for instance in corporations or government agencies, a disgruntled, disturbed, or merely venal employee will be blocked from easily copying up to millions of confidential and/or embarrassing documents to a compact device such as a simple USB Memory Stick® or other portable data storage media device, and then walking away with this in his pocket.

In the same context, it should be noted that, documents published under this invention can be made unsearchable by search engines by, for example, containing the content within strings, according to certain embodiments as described below.

According to an aspect of the invention, a method of governing content presentation of multi-page electronic documents includes providing, to a publisher, a document file. The document file includes a program file, and a text file functionally associated with the program file. The publisher provides at least the text file to an author. The author creates at least one version of a work of content based on the text file. The version includes a current version, which is parsed into defined units of content. The author provides the units of content of at least the current version of the work of content to a user, to be viewed by the user on a display device in a sequence determined by the author. Creating the at least one version of the work of content includes arranging the work of content such that a predefined action and/or a predefined condition causes
redirection of the viewing of the content from a current unit of content of the current version to a different unit of content of the current version, regardless of the sequence, and/or
revealing to the user previously unviewable units of content and/or concealing from the user a currently viewable unit of content, and/or
addition of a subsequent unit of content and/or removal of a current unit of content, and/or
replacement of at least one unit of the current content by a subsequent unit of content, and/or
replacement of the current version with a subsequent version.

The text file can be an empty text file.

The method can also include creating, by the author, one or more channels of subsequent content. Each channel of subsequent content includes one or more versions of subsequent units of content. These versions can be sequential or non-sequential. The author associates different channels of subsequent content with respective classifications of users. The work of content provided to a user having a classification is arranged such that a predefined action and/or a predefined condition causes addition of at least one unit of content from the channel associated with the user's classification to the current unit of content provided to the user.

Access to the program file by the user can be restricted, such as by denying to the user access to the program file, or limiting access by selectively denying to the user access to at least portions of the program file.

The method can also include modifying, by the user, the text file, to produce a modified text file. The modified text file may be stored only at a server and/or a node controlled by the publisher and the publisher can restrict access to the stored modified text file. Access to the stored modified text file can be provided to another user, for example, on payment of or agreement to pay a fee.

Providing, by the author, the units of content of at least the current version of the work of content to a user can include providing the units of content on a first portable memory device registered for use only with one or more authorized reading devices. In this case, the method can also include modifying, by the user on an authorized user reading device, the text file, to produce a modified text file. According to this embodiment, the modified text file can be stored only on the first portable memory device or a second portable memory device that is registered for use only with one or more authorized reading devices including the authorized user reading device. The second portable memory device is associated by the publisher with the first portable memory device. The publisher can restrict access to the stored modified text file.

The publisher can grant access to a user website to the user. In this case, providing, by the author, the units of content of at least the current version of the work of content to a user includes making available the units of content to the user at the user website. The user requests access to the units of content at the user website, and the units of content are stored on a storage device that is coupled for communication with the display device. After the units of content are stored, at first fewer than all of the units of content are provided to the user. The user then provides a user code, which the publisher evaluates. Additional units of content are provided to the user if the user code is valid, and access to the additional units of content is denied to the user if the user code is not valid. The additional units of content can be accessed for display on a display device.

The method can also include modifying at least the text file such that a background is a background color, and modifying at least the text file such that text is a text color that is substantially similar to the background color.

Providing, by the author, the units of content of at least the current version of the work of content to a user can include providing initial units of content to the user, in this case, the method also includes providing, by the user, a user code. The publisher evaluates the user code and a device code associated with a portable memory device coupled for communication with the display device. Additional units of content are stored on the portable memory device if the user code and the device code are both valid. A fee can be charged to the user prior to storing, viewing, or otherwise providing access to the additional units of content. Access to the additional units of content is denied to the user if the user code is not valid.

The additional units of content can be stored by use of a modified web browser authorized by, and registered with, the publisher, only if a browser code associated with the web browser is validated by the publisher, and access to the additional units of content is denied if the browser code is not validated.

The method can also include registering the portable memory device by registering the device code with the publisher and storing, by the publisher, an executable file on the portable memory device. The executable file is designed to communicate with the publisher and with the display device to control presentation of the content on the display device. The method can also include providing, by the user, identifying information and/or an answer to a question. The publisher can change the user code in response to receipt of the identifying information and/or the answer to the question.

The units of content can include a sound file and/or a video file. The text file can include at least one tag; when the user reaches the tag while viewing content, presentation of the content is redirected to a unit of content that includes the sound file and/or the video file for presentation to the user. Presentation of the content is returned to the tag after presentation of sound file and/or the video file, and/or performance, by the user, of a predetermined action.

Providing, by the author, the units of content of at least the current version of the work of content to a user can include providing initial units of content to the user for viewing in a browser widow that is registered with the publisher for use by the user. In this case, the method can also include providing, by the user, a user code. The publisher evaluates the user code and a device code associated with a portable memory device coupled for communication with the display device. Additional units of content are stored on the portable memory device if the user code and the device code are both valid and are both associated by the publisher with the registered browser, and access to the additional units of content is denied to the user if the user code is not valid. A fee can be charged to the user prior to storing the additional units of content or displaying the additional units of content. It can be the case that the user is allowed to modify the units of content only after storing the additional units of content on the portable memory device. The current version can be presented in a first browser window, and a second browser window can be opened in which the subsequent version is presented.

The method can also include providing, by the user, a user print code. The publisher can evaluate the user print code, and can allow the user to print a hard copy of the current unit of content or a subsequent units of content if the user print code is valid and deny print access to the user if the user print code is not valid.

The method can also include applying a naming convention to the document file to indicate whether there is another unviewable unit of content to be revealed, another subsequent unit of content to be added, another unit of the current content to be replaced, and/or another subsequent version to replace the current version.

The predefined action can be a plurality of predefined actions. The author can provide the work of content to the user via a first mode of communication. The method can also include providing an explanation of the plurality of predefined actions to the user via a second mode of communication. Preferably, the second mode of communication is different than the first mode of communication. The program file can be modified by the author such that efficacy of the predefined action is limited to a predefined time period. The explanation of the plurality of predefined actions to the user can include a notification of the predefined time period. The work of content can be a table of contents that includes a plurality of hyperlinks or infralinks. Each hyperlink or infralink can provide access to the user to an associated respective further work of content within the current version. The method can also include designating the predefined actions in the program file by the author.

The method can also include replacing content by adding an overlay to the content. The overlay can provide information to the user related to the predefined actions. The overlay can include overlay content. At least some of the overlay content can include hyperlinked content and/or notes, footnotes, comments, hyperlinks, and/or action key information.

The method can also include parsing each said unit of content into strings, and associating at least one predefined action with a particular designated string.

The predefined action and/or the predefined condition can cause
previously unviewable units of content, arranged between previously viewable units of content as interleaved units of content, to be revealed to the user, and/or
a subsequent unit of content to be added, arranged between current units of content as interleaved units of content, and/or
the current version to be replaced with a subsequent version. The subsequent version includes units of content that were not present in the current version, arranged between units of content in the current version as interleaved units of content.

Each interleaved unit of content can be identical to an adjacent unit of content except that at least some text in the interleaved unit of content is hyperlinked text. The method can also include selecting, by the author, of a color of the hyperlinked text, individually for each item of hyperlinked text. The method can also include actuating an item of hyperlinked text, thereby redirecting viewing of the content by the user to an independent unit of content. Each interleaved unit of content can include a series of hyperlinked listings and descriptive content related to the hyperlinked text. The method can also include linking, by the publisher one hyperlinked listing to an associated other work of content. The user actuates the hyperlinked listing, and the user is allowed to access the associated other work of content if access is authorized by the publisher. If access is not authorized by the publisher, access of the associated other work of content by the user is denied.

The content can include hyperlinks. In some embodiments, units of content that include hyperlinks include only hyperlinks and are separate from units of content that do not include hyperlinks.

Each unit of content can include at least one delimiter. As used herein, a delimiter is defined as a sequence of one or more characters used to specify the boundary between separate, independent regions in the content data. Thus, when a user is consuming content and passes a delimiter, this is an indication that the user has moved on from consumption of one region to consumption of the subsequent region, or merely that the user has finished consuming the current region of content. In contrast, a tag would mark a particular location in the content, and not a boundary between two regions in the content.

In this case, the method can also include modifying a word processor interpreting the document file for presentation to the user to apply an inalterable delimiter number to each delimiter in the work of content such that each delimiter number is unique to the respective associated delimiter within the work of content. Preferably, display of the delimiter numbers to the user is prevented. The method can also include counting the delimiters passed by the user while the user views units of content to provide a delimiter count, or a plurality of individual delimiter counts. The delimiter numbers of the delimiters passed by the user while the user views units of content can be registered. The delimiter count is incremented only once for each registered delimiter number, regardless of a number of times the associated delimiter has been passed by the user. An indication as to whether the currently-viewed unit of content and/or the next sequential unit of content is associated with a delimiter number that has previously been registered is presented to the user.

It may be the case that there is a plurality of delimiters of at least two delimiter types, in which case the delimiters of each type can be counted separately from each other. A fee can be charged to the user as the user views content, and the fee can be incremented as the user passes each delimiter, such that the fee is incremented differently for at least one said delimiter type.

A delimiter can be used to specify a time element related to performance of the predefined action. The publisher can control access to the work of content by the user based on performance of the predefined action by the user with respect to the time element.

A delimiter can be tracked and registered when passed by the user as the user views content. An executable file can be installed on a portable memory device connected for communication with the display device, and used to perform the tracking and the registering of the delimiters. The delimiter can include a code-request, requesting the user to provide a code when the code-request delimiter has been passed by the user as the user views content. Only if the user provides a valid code in response to the request, additional content is provided to the user in response to receipt of the valid code; otherwise, the additional content is not provided. A fee can be charged to the user prior to providing the additional content. The publisher can require provision of the valid code before letting the author provide the units of content to the user. The publisher can request provision of the valid code only after a predetermined period of time has elapsed. The publisher can require provision of the valid code whenever access to the work of content by the user has lapsed by a predetermined period of time before letting the author provide the units of content to the user.

The code can be a time-code.

Each unit of content can include at least one string. That is, a unit of content can be defined as a string, or a unit of content can be made up of a number of strings. As used herein, a string is defined as a variable or fixed sequence of characters, generally understood by the program file to be a data type and implemented as a data structure that stores a sequence of elements using some type of character encoding. Storage in memory can be statically allocated for a predetermined maximum string length or dynamic allocation can be used to allow a variable number of elements to be included in the string.

When the user provides a valid code in response to the request, presentation of the content to the user is redirected to a target string, in response to receipt of the valid code. The valid code can be a predetermined key or succession of keys. The target string can include at least one additional delimiter. A word processor interpreting the document file for presentation to the user can be modified to apply an inalterable string number to each string in the work of content such that each string number is unique to the respective associated string within the work of content. Display of the string numbers to the user can be prevented. The predetermined action can be changed based on the particular string of content being viewed by the user. An extent of redirection of the viewing of the content from the current unit of content to the different unit of content of the current version can be limited through function of the program file. The extent of redirection can be measured in a number of strings.

### BRIEF DESCRIPTION OF THE DRAWINGS

FIG. 1 is a block diagram of an exemplary document file.

FIG. 2 is a block diagram of an exemplary embodiment of content.

FIG. 3 is a flow diagram that shows an exemplary general process of the invention.

FIG. 4 is a flow diagram that shows a particular exemplary aspect of the monetary charge process of the invention.

FIG. 5 is a block diagram of an exemplary integrated device according to the invention.

FIG. 6 is a flow diagram of an exemplary query process of the invention.

FIGS. 7 and 8 are flow diagrams of exemplary delimiter processes of the invention.

FIG. 9 is a block diagram of an exemplary integrated device according to the invention.

FIG. 10 is a flow diagram that shows an exemplary general process of the invention.

FIGS. 11 and 12 are flow diagrams that show exemplary general duplication-prevention processes of the invention.

FIGS. 13 and 14 are flow diagrams that show particular exemplary aspect of the copy process of the invention.

FIG. 15 is a flow diagram that shows a particular exemplary aspect of the authoring process of the invention.

FIG. 16 is a flow diagram that shows an exemplary general process of the invention.

### DETAILED DESCRIPTION OF THE INVENTION

The present invention provides a way for presenting a document consisting of text characters and/or other content to a viewer, such as a computer user, in multiple versions which can be temporally sequenced according to performance of an action or series of actions and/or satisfaction of a condition or series of conditions. For example, the depression of one or more predetermined control or action keys as specified by the author of the document being viewed can be such an action. According to the invention, a document can include words, letters, numerals, symbols, blocks of color, digital photographs, graphical images, movies, sound, any other visual and/or audio binary file, forms or interactive forms, structured data, markup language data, links, and Web pages, which can be presented on a viewers display sequentially as two or more versions, both of these or all of these controlled by the reader using an action key or keys, the second and/or later versions being brought before the viewer only once he or she has struck the pertinent action key, or, according to an alternate construction of the invention's program file, automatically being brought before the viewer once a certain point or points in a document file, as determined by the document's author, has or have been reached by the viewer, such points being, for example, the end of the last string and page of the first version of the document.

In a general embodiment of the invention, presentation of content to a user, also referred to herein as a reader or viewer, is controlled by the actions of a publisher and one or more authors. The content is provided through the use of a document file, which includes a program file, as well as a text file functionally associated with the program file. The program file enables generation of content by the author that is presented to the user in a prescribed manner that can vary according to actions performed by the user, or events that occur during the user's consumption of the content.

The publisher provides at least a portion of the document file to an author so that the author can generate content. The author creates at least one version of a work of content based on the text file. Because the content can change, either in substance or presentation or both, over a lifetime of the dynamic work of content, the version presented to the user for current consumption will be known as the current version. This version, and all versions of the work of content, is parsed into defined units of content, which are presented to the user sequentially. For example, the author might define a unit of content as being a “page”. A page of content might be defined in size by the size of a screen of the user's display device (computer monitor, tablet screen, smartphone screen, dedicated reading device screen, etc.). Alternatively, a page of content could be more than a screen's worth of content, and therefore could require scrolling on the part of the user to view an entire unit of content. Regardless, the author defines the unit and presents the content to the user unit-by-unit in sequence.

As the user views or otherwise consumes the current version of the work of content using the display device in the sequence determined by the author, performance of a predefined action or satisfaction of a predefined condition can cause one or more changes to the presentation of content to the user, as arranged by the author.

For example, in response to the action or condition, viewing of the content by the user can be redirected from a current unit of content of the current version to a different unit of content of the current version, out of sequence, either forward or backward. Thus, from the users perspective, the current unit of content would no longer be viewable, and in its place a different unit of content of the current version would be viewable. Again, this redirection could take place in response to performance of an action on the part of the user, in which case a response, although not necessarily a particular response, most likely would be expected by the user. Alternatively, this redirection could take place as the result of a condition, in which case it could be that the user would not expect any response at all, although the redirection might take place in a manner such that the user does not realize that a redirection has taken place. In any case, presentation of content to the user will be redirected from one unit of content to another unit of content.

According to certain embodiments of the invention, the current version of the work of content might have units of content that are not initially viewable by the user. These units are concealed in some manner, such as by appearing to be blank units and/or by being skipped in sequence according to the wishes of the author. Because content is presented to the user in discrete units, these unviewable units can be disposed between other units of content, such as between units of viewable content or even mixed in with other units of unviewable content, as interleaved units of content. Unviewable units of content can be disposed after a “stop” delimiter or a “delay” delimiter in the same string as viewable units of content, as described in more detail below. In response to the action or condition, certain, but not necessarily all, previously unviewable interleaved units of content of the same version of the work of content can be revealed to the user. Of course, these additional units of content can be arranged before the first viewable unit of content or after the last viewable unit of content, in which case they would not be interleaves. Alternatively and/or in addition, previously viewable units of content can be concealed from the user in the currently viewable unit of content. For example, if a response includes concealing the current unit of content and revealing an interleaved unit of content while incrementing the sequence of presentation of the units by redirection, from the user's perspective the current unit of content will be replaced by a subsequent unit of content.

In some cases, the work of content will be updated by the author in some manner, even while the user is currently in possession of the current version of the unit of content. In such a case, an entirely new version of the might be made available to the user as a subsequent version of the work of content. In other cases, perhaps only one or more selected units of content might be changed or added, and only those units would be made available as replacement subsequent units of content. In these or similar cases, one or more subsequent units of content can be added, one or more current units of content can be removed, and/or the entire current version of the work of content can be replaced in its entirety by a subsequent version of the work of content, in response to an action or condition.

The disclosure above is a very general description of elements of the basic functionality of the method of the invention. Numerous exemplary embodiments are described below that provide more detail and in which additional and alternative functionality are included, all within the intended spirit and scope of the invention.

According to an exemplary embodiment of the invention, after a designated action by the user, the initial version of the document is replaced by the second version, which may include more, different, or otherwise less material than the original document. For example, the initial version can be replaced with a second version that is identical to the initial version with the exception that it includes additional text on or following some or all of the pages of the initial version. Per a decision made by the author or editor, an indefinite number of subsequent versions can be presented, each differing in some manner from the one previous to it. Thus, a one-page document can be replaced, for example, by a similar document having as a second page, the first page now with certain annotations. Or otherwise, a “logically complete” single-page document can be supplemented by one or more additional pages that are subordinate to or otherwise related to it. A document can continue to be expanded through the presentation of subsequent versions serially. The initial version can include, constitute, or encompass typed or hand-written notes, an author's outline, précis, or summary, or any other preliminary aspect of the writing process that then will be developed through the presentation of subsequent versions into a progressively more complex and/or complete work of description, narration, persuasion, and/or explication.

It can also be the case that notes, an outline, and/or other preliminary aspects of the writing process can follow a complete work, or be placed within it at an intermediate point or some intermediate points.

An electronic document, after having been published, can be modified by the author or editors, for instance, to discuss continuing developments in a news cycle or in a course of scientific discovery, to embrace readers' comments including criticisms of the initial document, or simply to air the author's or editors' further reflections on the subject matter after some passage of time. Such additional material can be folded into the initial version in the form of additions to, alterations of, and/or annotations on the original pages, or can be made up into a more complex and refined, separate, new serial version; per the author's preference in either of these cases, some or all of the original pages of content can be retained unchanged whether they are moved to a new location or not, or all of the original pages can be discarded in the newly modified version.

Versions of the document can differ by the presence of “interleaves” disposed in a second and any subsequent versions of the document as presented to the user, each version of the document file being sequentially read by a microprocessor device according to instructions contained in the program file and subordinately, the text file. If for example there are two versions of a document within the document as it is published originally, the first version can bypass or not include all of the interleaves and only the second version offer the interleaves in their proper order. Or, the interleaves can be present in the first version, or second or further versions, but not viewable until activation of a particular action key by the user; or otherwise, interleaves pertaining to the first version, or second or further versions, can be present elsewhere than within the respective version and not viewable except with activation of a particular action key by the viewer, with activation of the same or different action key required to return the viewer to the respective version.

In other words, the electronic publication can have one or more interleaves hidden between designated pages or sections of the document as originally presented to a viewer. When different versions of a document are present within a document, each one can have different interleaves. These interleaves normally will be hidden from the reader so by the document's author's design, the viewer will not see them the first time reading through the book. Then, after a predetermined action, such as actuation of a predetermined key by the viewer, the second version of the content is presented to the viewer. The second version includes interleaved content that was not available to the viewer when accessing the first version (unless incorrectly, the reader engages in the predetermined action to summon the interleaves other than at the point or points intended by the author).

Preferably, the viewer is automatically brought to the beginning of the content when accessing the second version, although this is not necessarily the case. If the author wishes to, he or she may create at the beginning of the first, second, or any further version a “hidden preface,” an indefinitely large number of pages and strings that will be presented to the viewer only once he or she activates a particular action key, the hidden preface in any version therefore being accessed before the reader reaches for a second time, the first page of that version. In a like manner, if the author wishes to, he or she may create at the end of the first, second, or any further version a “hidden afterword,” an indefinitely large number of strings and pages that will be presented to the viewer only once a particular action key has been activated by the viewer, and after the end of the last page and string of the first, second, or any further version has been reached by the viewer.

Thus, if an author wishes to write such an “invisible preface” that initially cannot be seen by the viewer, he or she may do so by interspersing a certain number of blank screens that will be passed over as the program is automatically progressing to the first page at which presentation will stop; to do this, the author may alternate blank “main,” automatically viewed pages with a coordinate number of interleaves. Similarly, an “invisible afterword” can be created. In both cases, the program will proceed automatically and rapidly in succession through these blank main screens because the author will not have inserted a “stop delimiter” within the strings coding for each of these blank main screens. The initially invisible preface or the initially invisible afterword can be of any number of pages in length, according to the author's preference.

Thus, according to the invention, the author or a commentator can provide interleaved material that complements or comments on the original material. For example, the interleaved content can include notes by the author of the original work, scholarly comments and interpretations by others, and historical and geographical facts related to passages in the content provided. Material in interleaves may be written by the author, editors, or later commentators, and interleaved material may qualify or advance the initially presented material.

Educational material, other non-fiction works, or essay “interleaved” publications may be pitched at two levels: on the first level, to the reader who is somewhat new to the information and to the conclusions that the author wishes to convey, and on the second level, to the same individual who is now familiar with these in outline and is ready to be exposed to and to take in, through a non-linear commentary on the simpler work, more advanced ideas that are more nuanced and more emphatic and focused than is possible in conventional, linear, publishing. Via use of the invention, readers will be provided with a more nuanced and complex analysis of ideas and facts, or a more “qualified” and tentative presentation of ideas and facts, or a more advanced presentation of ideas and facts, than they could have been, before. Furthermore, works of fiction, including adult, children's, and juvenile fiction, as well as comics and graphic novels, can be published according to the invention. Likewise, works consisting in part or in their entirety of pages containing photographs or other works of art can be published according to the invention.

From a commercial standpoint, the invention provides advantageous ways to generate revenue. For example, a publisher of the content can make the first version of the content free of advertising, but can include paid advertisements in some or all of the interleaved content revealed in the second version. Alternatively, the publisher can provide a free, first incomplete summary version, and a second, more complete version of the same that is available only on payment of a fee. To access the second version, readers can be required to pay at a constant rate or at an often-varying or a constantly varying page-rate, as determined by the publisher. A publisher can offer readers the option of previewing a predetermined fraction of the content without charge to determine their level of interest, before they decide to begin paying to access further parts of the complete publication.

A single action key to invoke the second version of a document will be referred to herein, but the invention is not contemplated necessarily to be limited to a single action key, and more than one key can be designated as action keys if desired. More than two versions of a document are possible; thus, more than one set of interleaves are possible. If more than one set of interleaves are authored, the same action key or more than one action key can be used to summon the different interleaved versions. The action key can be, for example, the <LEFT-ARROW> key on a standard computer keyboard. Specialized keys on a dedicated device can be provided to implement functionality.

According to a particular embodiment of the invention, series of additions to or alterations of an original version of a document can be presented sequentially to the viewer, wherein the sequencing of the modified versions is predetermined by the author at the time of authoring of the text, and the viewing of a first or subsequent modified version can be invoked by the viewer according to the depression of an action key.

For example, a document, such as a book in electronic form, can be presented to a viewer. This document can be stored locally, such as in memory in a computer or a portable electronic device on which the document is viewed. Alternatively, the document can be stored remotely, such as on a remote computer, and streamed to or otherwise provided to a computer or other electronic device via a network or peer-to-peer connection.

Multiple action keys can be utilized, such that pressing any of these will return a reader to a different “re-starting point” in the original document. Such keys preferably are sequential number keys, letter keys, or combinations of keys, but may be any ordinary keyboard keys designated by the author or publisher. They may also be special keys on a specially designed dedicated device. A second “back function” and/or a second “forward function” can be used to allow the reader to progress backward or otherwise forward through a document one string at a time—that is to say, without any interleaves being “jumped over” as would be anticipated for instance when the viewer was proceeding through a document in the forward direction for the first time—for example to permit an author to expand on the meaning of a new term or concept that appears in the original text, now in notes presented in the preceding or otherwise the following interleaf. Where such a “string-at-a-time” function is operable, the program file can be modified to limit the number of back or the number of forward keystrokes permissible at one time, in order to prevent reader confusion and/or to prevent fee delimiters from being bypassed. For the same reasons, the program file can be modified to prevent back-to-the-beginning or back-to-another-point keys from being activated before a reader has reached a predetermined point in the document.

An author can modify the operating program's “skip” number—the number of interleaf strings that are automatically skipped over per “forward” action key strike by a user during a first reading of a document—this number, the number of interleaf pages found between every pair of pages of original text, plus one.

Where the skip number is greater than one, readers who have been advancing through interleaves one at a time, at the author's discretion will encounter at least one blank screen before reaching the next “main” page. In, for example, a document where between every pair of pages of original text there are always three interleaves, the first in a set can refer to the prior page of original text and the second can be blank, whereas the third can refer to the following page of original text.

The optional availability of interleaf pages other than simple blank pages at a point in a document may be made known to users through placement of a “flag” in the original text by the author or editor. As necessary, this flag will designate the specific key to be pressed, for example, the “plus” or “minus” key.

The original “very simplest” version of the document, in this example a book, can be provided to the viewer, either for free or on payment of a fee or purchase price. When the viewer has finished reading the book, or at another time of the viewer's choosing, the viewer can, by going back to the beginning of the book, or by going back to another point in the original version of the book that has been chosen by the author as a re-starting point—or by otherwise indicating that he or she wants to view the second version of the book—view previously unseen material; alternatively, the viewer can be brought back automatically to the beginning of the book or to any other re-starting point when he or she has reached a certain point or points in the original version of the book as determined by the author. At that time, the previously unseen material, including the previously-missing “interleaves,” will be presented to the viewer. The viewer may have to provide payment to view the second version. In particular interleaves provided can include, for example, formatted and in-a-different-background-color “boxed notations” resembling footnotes, which need not be located at the bottom of a page, yet may be disposed in any location on a page, to provide insight into different aspects of the book. It could be the case that these aspects of the book were not presented by the author in the initially viewed version for reasons of comprehensibility. The notations can include, for example, scholarly insights, references, illustrations, and links to related reading material that was written by the same or other authors. The ability for the viewer to highlight or add his or her own notations to the original text or interleaved text can also be enabled by the reader through summoning the source code of a document, and then altering it by adding his or her own “reader's notes.” Such notes may comprise passages added by the reader at the end of pre-existing paragraphs or screens of text, or may be made to appear anywhere on the screen in colored “boxes,” formatted by the author using the Cascading Style Sheets (CSS) function of HTML, for example. Paid advertisements that must be read or watched by the reader before proceeding to further interleaves, or past “stop delimiters” to further notations within a single interleaf, can also be included. Interactive content, such as questions asked of the viewer, to which the viewer may or must respond before proceeding further in an interleaved version, can also be included. In this case, subsequent material or a complete, subsequent version consisting of additional interleaves can be provided if the viewer has correctly answered questions that have been written by the author. Alternatively, additional interleaves can be provided to a viewer regardless of the correctness of the reader's answers, yet the price that the reader pays per page to generate further interleaves can be incremented or decremented according to a predetermined mathematical formula, depending on the correctness of the reader's answers.

According to an alternative embodiment of the invention, the initially presented version of the document is a concise and abbreviated version, or an abridged version, which becomes complete in the second version or in another subsequent version. This allows the publisher to give a prospective purchaser a preview of a book or other content at no or little cost in the first version, and the complete document in a subsequent version, on payment of a fee and/or acceptance of advertisements. The content that completes the document, and any optional advertising, is present in interleaves or in main pages that are only accessible to the viewer in the second or a subsequent version. Interleaved pages available only in the second or subsequent versions may greatly outnumber those available in the initially seen version, so that only a spare outline of the document can be previewed.

In one embodiment of the invention, delimiters can have an effect only when they are in a string that codes for a “main page.”

To implement the method of the invention, text is written by an author/programmer so as to be read by a reader's computer, or other microprocessor-driven device, as computer code. This code can be, for example, similar to or no different from ordinary HTML code, yet the method of the invention provides several advantages. The code includes delimiters that the author can use when writing/coding that will stop or delay presentation of content to the viewer, charge viewers a variable amount as that point in the document is passed, or return to the beginning of the document. These delimiters can be combined. So, for example, the document can be returned to the beginning after passing an end-of-document delimiter, at which point, once progression of the document has stopped, the viewer can be prompted for payment as a condition to view the subsequent version of the document, including interleaves.

In a preferred embodiment, the text or other content is authored such that text, or the ordinary language of HTML or XHTML or another compatible language for the Web, is augmented with new delimiters. The text is coded by the author in strings that include the delimiters, wherein each string presents a new screen of text. For example, a string can begin with
LABEL(“ . . .
   and end with
. . . )”;
   to identify delimited text, where “LABEL” is a label chosen by the author to designate the delimiter. A first delimiter allows the author to stop presentation of the content until the viewer has struck an “advance” action key, while a second delimiter allows the author to delay presentation of the document a preset number of tenths of a second (or other time period), and a third delimiter allows the author to return presentation of the document to the beginning or some other point in the document, irrespective of any action by the reader. Although three such delimiters are described herein, additional or different delimiters can be used to provide similar or different functions, as will be apparent to one of skill in the art. According to the method of the invention, all formatting features of HTML can be used. Retaining the broad feature set capability of HTML provides great advantages to the author.

Annotations can also be made to appear or go away at the stroke of an action key. For example, these notes can appear in indented and highlighted boxes, or in any other format of the author's choosing, once the interleaves are enabled. Annotations can be made to appear or go away on a non-interleaf screen as well. Highlighting or other emphasis of text can also arise, timed to appear automatically according to the author's specification or on depression of the action key by the viewer.

HTML documents can be made to appear as advertisements that appear on the viewer's screen, one by one, in a timed sequence or at the control of the viewer, once interleaves are enabled in a second or subsequent version. For boxes or pages to appear in an automatic timed sequence within or as a complete individual string that makes up a non-interleaf page, that is, a “main” page, a delay delimiter can be inserted. For example, ̂̂25̂ or a similar delimiter is inserted, where “̂” is a space, and where “space-space-number-space” is the incremental delay delimiter denoting the number of incremental delay units selected by the author/programmer, here measured in tenths of a second. Advertisements can be made to appear or go away in a non-interleaf page; and in this case, further progression by the viewer can mandatorily be paused for a defined interval at the advertisement through the emplacement of a delay delimiter after the advertisement. Likewise, in non-interleaf pages “space-space-vertical pipe-space” (̂̂|̂) can be used as the “stop until the action key is depressed” delimiter, so that pages can change at the control of the viewer. An “automatic blank screen” string, for example,
LABEL(“ ”);
   can be made to occur between non-interleaf strings, to generate a momentarily blank screen between screens of text. At the same time, insertion of such a blank screen will cause the first element of the following screen to be placed correctly in terms of its vertical location on the screen, rather than being placing arbitrarily according to the location of the elements that were last read in the prior screen. As an alternative method allowing the first elements of a page to be located initially at the top of the page, a delay delimiter can be emplaced as the first element of the respective string. Or if desired by the author, the topmost elements of a page can be located initially other than at the top of the page through suitable manipulation of the “height” term in a corresponding DiV.

According to an exemplary general process of the invention, the author creates a document file by authoring content that preferably includes text. Predetermined portions of the text are delimited in order to define delimited content. The document file is then read by a microprocessor device and displayed to a viewer, and the delimited content is displayed differently than other portions of the content of the document file according to the nature of the delimiters chosen by the author/programmer. The coding of the delimiters can be made transparent to the author, because this coding is concealed in the document file within the program file, separately from the text file and in a way that the author is not expected to modify, or need to modify. Therefore, computer programming skills are not needed at the time of authoring or formatting of an article or book. For example, an author may apply any delimiters of his or her choosing through utilizing the same word processing program he or she uses to author ordinary static-text documents. Regardless of location, delimiters will “drop out” in the sense that although they will have meaning to the microprocessor running the conjoint document and program files, the viewer will never see the characters or the spaces of the delimiters on his or her screen.

The document file need not only include text, and instead can be a multimedia file including still and moving images and sound as content, any portion of which can be delimited. Further, HTML files and XHTML files can be document files that are authored according to the invention, and at least the main pages in any section of such a document can be delimited for controlled presentation to a viewer.

As part of the authoring process, the author defines delimited content in the document file as the text file component of the document file is first authored, or later, in a separate delimiting action. The viewer will display the document on a microprocessor device such as a computer or dedicated document reader, which will identify the delimited content and present it to the viewer as specified by the author. If the computer or other viewing device is connected to a network, a conjoint text and program file can be stored on a server or in a location at which it can be accessed by a server, and a network interface program can be used to view the document file. Or alternatively, the text file and the program file can be stored in separate locations, particularly if the program file does not need to be altered to run a certain text file. For example, a Web browser running on a notebook computer with a wireless Internet connection can be used to view the document file through reference to the program file, where the conjoined text and program files can be accessed via the reader's typing in the Web address of the conjoined document (the text file as this is embedded within the program file) in a browser task bar.

The authoring process can include delimiting the content such that further action is required by the viewer to access the second version of the document file. As previously discussed, this action can include the use of an action key. The viewer will be able to display a portion of the complete document file, but subsequent viewing of delimited content will require additional action as specified by the author.

The authoring process can include placement of interleaved content, which interleaved content can be displayed after viewer action. For example, interleaved pages including annotation content on interleaved pages can be presented in a second version of a document after a viewer has read the first version, according to the designs of the author as he or she created the document file. This second version will be presented only after the viewer has pressed a “go-to-a-restarting-point” action key to return to the beginning of the document or to some other point in the document and view the second version of the document, or it will be presented to the viewer automatically, when the viewer passes a point or points in the document as determined by the author, these designated by author using a certain delimiter, for example a “̂̂∥̂” delimiter. The second version can comprise the first version of the document, but now between its main pages there will be the interleaves including annotation material as designated by the author; or otherwise, it can comprise a completely different version of the document, including one between whose main pages there will be interleaves.

Thus, the authoring process includes creating content and delimiting it so that presentation of interleaved content is controlled either automatically or by the viewer through activating an action key. The capability to author a document in this manner can be provided by any word processing program. This document, now in the sense of a “document file,” can be stored on a medium such as a portable memory device or a hard drive internal to a computer, or as instructions resident temporarily in RAM. The stored instructions can be implemented by a microprocessor device through reference to an unchanging or modestly modifiable program file, which will be combined with the document file or will be stored separately and cause a document to be displayed on an electronic device. Although in the exemplary implementation of the invention, the text file will be written in ordinary HTML or XHTML code, the program file preferably will be written in scripting programming language such as JavaScript®. Multi-page documents including interleaved versions will be presented as single web pages in an ordinary web browser. Text file code can be accessible to viewers, allowing them to modify their copy of the text file in the sense of adding their comments to their own copies.

Text for presentation according to the invention can be created by modifying previously-authored plain-text documents. Such plain-text documents are divided into strings, each string representing a single page or other predefined unit. Strings are marked up in a markup language, such as HTML, and delimiters are added. The resulting text file is inserted into the program, to be acted on by a program file that is also present in the document file.

An author can make simple modifications to the program file to adapt it to a particular text file. For example, he or she can increase the number of specifically targeted “back” keys and their targets' location, or change the number of strings skipped over when the original text is read. “Back” keys may also redirect the reading frame ahead, the name notwithstanding.

It is also contemplated that the invention can be embodied as an integrated device that includes the storage medium described above, as well as a microprocessor device and an electronic display device. The integrated device can include an action key in communication with the microprocessor device for initiating viewer action.

Although the invention has been described to this point in terms of viewing versions of a complete document, it is contemplated that a document can be divided, such as into chapters, and that the chapters or other components can be serialized individually, in order or otherwise, each component having one or more interleaved versions that can be presented to a viewer. For example, a sequence of strings, each representing an individual page in the document, can be written in such a way as to cause a table of contents to appear after a number of strings has been viewed, which table of contents will be hyperlinked so the process can resume in the selected document. Otherwise, the table of contents can be annotated to show “infralink” keys that may be used to redirect the user to the corresponding section of content this time within the original document—if such is done, then the summoning of the respective content occurring without a delay. With or without hyperlinks and/or infralinks, an ensuing document can be indefinitely long and can resemble a magazine, newspaper, or book, with any number of pages and any number of articles or chapters. “Chapter jump forward,” “chapter jump back,” and “jump screen behind” features, or other non-sequential access features, can also be provided through modification of the program file. Tables of contents can comprise simple hyperlinked or infralinked lists, or they can be more complex, including geometrically shapes, graphics, digital photographs, and text, created, for example, using HTML's “table” or Cascading Style Sheets “DIV” functions, preferably hyperlinked. “Advertisement boxes,” possibly hyperlinked to Web pages and possibly authored according to the method of this invention, can also appear on table of contents pages, or anywhere else in the document, including between pages of otherwise-continuous narrative text.

Other embodiments of the invention can relate to the tracking of content consumed by the viewer, and to charging a fee for content consumed by a viewer. For example, when an action key is depressed by the viewer as described above or when a “page back” key is pressed, an incremental charge can be incurred, to be debited from a pre-paid account or to be charged at a later time. This charge can be incurred in response to every depression of the action key, forward or backward, or per a predetermined multiple number of depressions, or according to any scheme devised by the author and implemented as a revision in the program file. If desired, charges can increment as the viewer moves forward through the document, irrespective of action-key depression, depending for example on the reader's passing the end of strings, or passing “delay” delimiters. Thus, interleaved pages can be presented to a viewer individually, with the understanding that a set fee or a variable fee, as determined by another delimiter, will be paid for each accessed interleaved page. The invention can be used to track usage and charge the viewer accordingly.

Alternatively, a special delimiter can be added to the textual content of non-interleaf pages such that the act of “passing” the delimiter by the viewer automatically results in an incremental charge to the viewer. Such a delimiter might be, for example, “space-space-vertical pipe-number-space,” where the number can be varied by the author and indicates the fee assessed for passing the delimiter in tenths of a dollar.

These or similar methods can permit an author to monitor any key depressions and/or forward or backward progression through content, and consumption of content in selectable portions, such as words, paragraphs, pages, etc. This consumption can be tracked and counted, and the viewer can be charged correspondingly. Alternatively, the resulting data can be used by an author, editor, or publisher to understand reader interests and habits better. Likewise, it can be used by the publisher of a periodical published under this method to determine staff writers' compensation, and to assist the publisher in fulfilling other functions specific to the role of publisher.

The content as seen by the viewer can include an indication of his or her current incurred charges, preferably at the reader's option. For example, a small window or other display region can be provided, in which is shown the total current charges incurred by the viewer. If a viewer is required to answer test questions as he or she proceeds through a document, his or her current score can appear in this window or other display. A resulting mathematical factor may be utilized by an author to determine a factor by which the viewer's per-delimiter fee or per-page fees will be multiplied, and this factor can also be shown. This display region can also inform the viewer when a charge delimiter has been reached or passed. Likewise, a document can be made to provide an indication, such as an audible indication, to the viewer whenever the total amount has been incremented, or will be incremented upon an action key's being pressed, or has surpassed a predetermined threshold amount set by the viewer or publisher.

Off-line viewing of documents can also be permitted, with content consumption and associated charges determined only when the viewer next logs on to the content-provider's Web site. While off-line, through attending to their fee total, viewers can limit their consumption to remain within a preferred tolerance.

Thus, according to the invention, the author of a document can control the manner in which document content is displayed to a reader. For example, an incomplete version, followed by a more complete version, followed by still more complete versions, some or all of which might be annotated, can be provided to the viewer in sequence, through the use of interleaved content. Advertisements can be included as at least a portion of the interleaved content of any version. Also, fee delimiters can be included within the interleaved pages and ordinary pages of a document in order that a publisher, author or editor, or later commenter can levy appropriate fees of viewers commensurate with their consumption of the document. Code can be added to the program file of an electronic document, in order to prevent “malevolent users” from employing an action key or key combination in particular “prematurely,” as a means of causing the CPU to pass over and not meaningfully read all fee delimiters encountered subsequently. This element of the invention allows viewers to be charged on a “by-consumption basis” not merely for use of interleaves but also for use of ordinary pages.

The present invention includes the method as described above. Within the scope of the invention, the method can be implemented as a computer program that can run on a computer or any device having a processor, including a dedicated reading device. The program can be loaded onto the computer locally, or can be implemented over the Internet or any other network. The invention can also be embodied as a non-transient storage medium on which are stored instructions that can be interpreted by a processor to cause a computer or other device to perform actions according to the described method, as described above.

The invention can also be embodied as a computer or other device on which the method is performed. For example, a general-purpose computer, including a processor, memory, one or more input devices, and a display of some sort, set up to view text as described herein, or set up on a network or as a stand-alone device and receiving documents authored according to the invention, is contemplated as falling within the scope of the invention. A special-purpose device dedicated to reading documents authored according to the invention is likewise contemplated. For example, document files can be loaded onto and stored on a portable memory medium that can be communicatively coupled with and read by such a special-purpose device, or document files can be downloaded onto such device via a network or directly from another computer or other electronic device. Such a special-purpose reader will preferably be portable and will present documents to a viewer. Such a device can be functionally simple, including a display, action keys, and a pointing device that can move a cursor to navigate the table of contents of a document being read. For example, a portable console having a suitable display can be provided with a touchpad pointing device and buttons, advantageously located for manipulation by a reader. The buttons can be used as action keys, such as the action key to move a document forward, the action key to move a document backwards a page at a time, and the action key to return the viewer to the beginning of a document, from which he can begin to view interleaved versions. In combination with the touch pad, action keys can be used to navigate a table of contents, index, end note indicators, or other hyperlinked text. For example, a portable console having a suitable display can be provided on its rear surface with a touchpad pointing device and a single button, advantageously located for manipulation use by the reader as an action key. Lateral movements made with the index finger of one hand on the touchpad device can be translated by the device into vertical movements through the table of contents.

It is also contemplated that more than one action key can be specified, or provided on a dedicated device. For example, the left-arrow key on a typical keyboard can be designated to be used by the viewer to drive the presentation backwards a page at a time. For example, using this key, a bit of content can be viewed more than once. Likewise, the right-arrow key on a typical keyboard, through being pressed by a viewer continuously, can be designated to be used by the viewer to return the document to the point where the viewer had left off, regardless of how many times the left-arrow key and/or the Enter (action) key had been used in the intervening time. Up-arrow and down-arrow keys can be used by the reader to navigate a page longer than a single screen. If a special-purpose device is created dedicated to reading documents authored according to the invention, right-arrow, up-arrow, and down-arrow keys may be added to the rear surface for use by the reader. Alternatively, all four keys may be placed on the front of the device, or the screen itself may be utilized as a touch-sensitive element, preferably without visual designation of the specific areas of sensitivity.

Thus, it is apparent that the invention provides a number of advantages over static text as it is presented in printed books and magazines and in electronic books.

Furthermore, whereas electronic books and multipage commercial word-processor documents such as those generated in word processing software such as Microsoft® Word® presentation software such as Microsoft® PowerPoint®, and portable document format software Adobe® Acrobat®, necessitate transmission by fast-speed Internet connections because of their large file sizes, moderately long articles authored according to this method, if they employ only text, can have file-sizes of only a few tens of kilobytes, allowing even long articles and books to be downloaded quickly, regardless of whether users are restricted to using a pre-modern Internet connection, such as a slow dial-up connection.

The following is a non-limiting example of content provided to a viewer according to the invention. A document is provided to a user as a file incorporating HTML and scripting programming language such as JavaScript®, preferably as an email attachment or as a direct download either to a portable device such as a laptop, smartphone, or tablet computer, or to a non-portable electronic device such as a desktop computer, or to a dedicated document reader. Once the file is opened in a Web browser, it is presented to the viewer as a series of pages, which each can contain any combination of text and other media content. Each page can be sized to be viewed on a single screen of the viewer's device, or can be scrollable. If according to author's wishes, during presentation of a document the current page does not automatically progress to the next page, then when the viewer has finished consuming the content on a current page, he or she actuates a predetermined key to move on to the next page. For example, pressing the right-arrow key on a viewer's computer keyboard or dedicated reader keypad can advance the content to the next page. Of course, touching the right-arrow zone on a touchscreen of a touchscreen-enabled device would have the same effect.

According to the invention, it is possible that the next page will deviate only infinitesimally from the prior one, for example only in the coloring or font style, bolding, italicization, underlining, or highlighting of a single word, or can deviate more markedly from it, through, for example, the addition of a commenting text box or boxes; or the two pages can be entirely different from each another, or can be no different from one another whatsoever.

Once the viewer has consumed all content in the current version of the document, or has consumed all desired content up to a certain point in the document, or again if the viewer simply decides at some point, for arbitrary or non-arbitrary reasons, to switch to reading original pages together with their respective interleaves sequentially on first exposure—assuming that this option is allowed viewers by the author of a document—he or she can summon the second version, again by pressing the appropriate targeted key. For example, by pressing the left-arrow key the viewer can return the document to the first page, or any other target page—whether an original page or an interleaf page, including pages beyond the last page viewed by a user at this point—according to the desires and direction of the author. Subsequent pressing of another action key, such as the “equal” key, can then advance the viewer through the second version of the document string by string, one at a time, yet so that this time interleaved pages or sections associated with the second version will be viewable. These can include advertisements. The process is repeated and, at the option of the publisher, a third version and associated interleaves can be provided to the viewer. Prior to providing each version, payment authorization can be required of the viewer. This payment can be made at the time the next version is requested, such as by debiting a pre-paid account belonging to the viewer.

From an authoring standpoint, if the first string of the document is chosen by the author as the target, the left-arrow function can be programmed to reset the string counter to 0, thus returning the viewer to the first page, the utilization of other targets necessitating the resetting of the string counter to other numerals, of course. Additionally, the right-arrow function can be programmed to increment the string counter by an integer larger than 1 while the first version of the document is displayed, so that interleaved pages will be skipped.

In alternative embodiments of the invention, pre-leaves and post-leaves, rather than or in addition to interleaves, can be included in the document file.

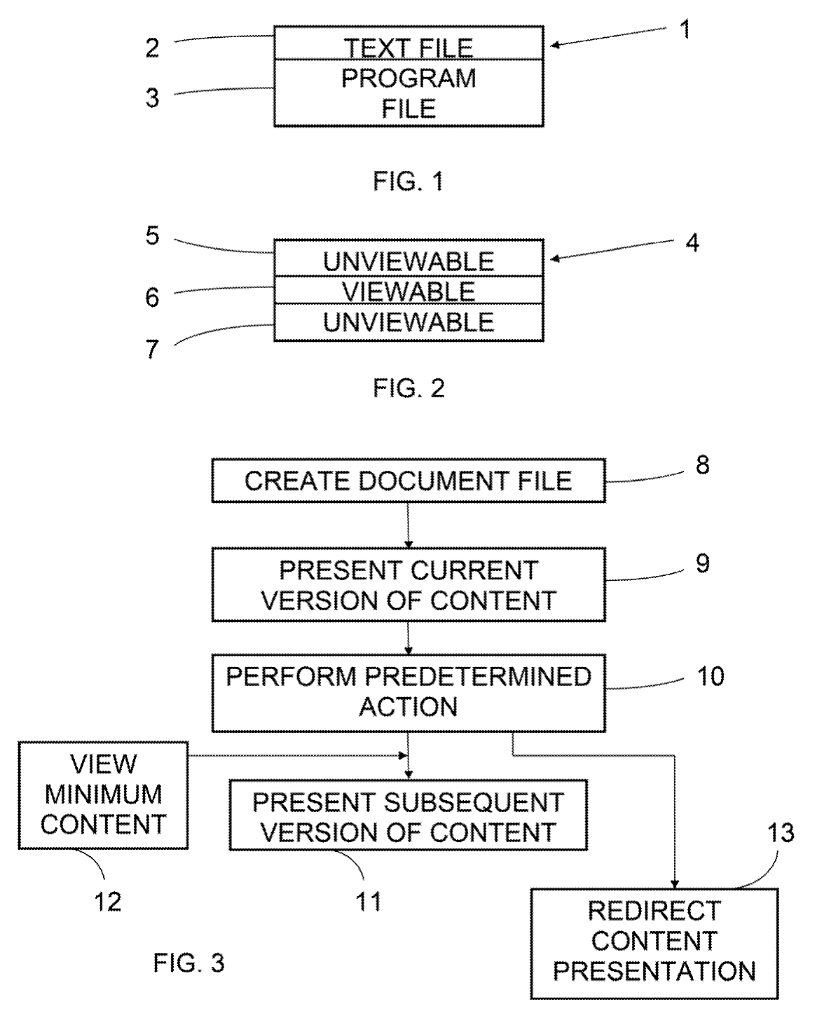

As shown in FIG. 3, such a method includes creating a document file 8, which includes a text file portion 2 and a program file portion 3 (FIG. 1). The document file is a variable computer-readable file that includes content. When the document file is opened, the content is presented to a user on an electronic display device, in discrete units according to a controlled sequence. As shown in FIG. 2, the content includes viewable content 6 and unviewable content 5, 7. In the example shown, some unviewable content precedes the viewable content 6 in sequence, whereas other unviewable content 7 follows the viewable content in sequence, although the sequencing of viewable and unviewable content units can be configured any manner according to the invention, as is apparent to one of skill in the art.

According to the exemplary embodiment shown, a current version of the content is presented 9. In this current version, fewer than all of the units of the content are viewable by the user, that is, only currently viewable units of content are viewable by the user. The unviewable units of content preceding and following the viewable units of content cannot be seen by the user when the current version of the content is being viewed. The user views the viewable units of content, which advance unit-by-unit through a predetermined sequence, either automatically or by action of the user.

At some point, a subsequent version of the content is presented to the user, again either automatically or by action of the user 11. According to this exemplary embodiment, the user performs a predetermined action 10, in response to which the subsequent version of the content is presented 11. The subsequent version of the content varies from the current version in some respect. In this example, at least some of the units of content that were unviewable in the current version of the content are viewable in the subsequent version of the content. This subsequent version of the content might be the final version, or further subsequent versions of the content can be presented to the user in this manner, each of which can vary from the previously-viewed version in some respect. The previously-unviewable content can be additional text, such as explanatory text or text that is revealing in some way and that completes or extends the content that was previously viewed. Alternatively, the previously-unviewable content can be annotation content, commentary, bibliographical information, advertising content, or any other content that is subsequently added to the current content, as part of one or more subsequent versions.

Thus, the user reads the current version of the content until such time as he or she is presented with the subsequent, different version of the content, in this case when the predetermined action is performed by the user. In response to performance of the predetermined action, presentation of the content can also be redirected to a different unit of content 13. For example, presentation of the content can be returned to a previous unit of the content, such as the first unit of content viewed by the user. Alternatively, the different unit of content can be a unit of content that was previously unviewable, such as content prior to the beginning of the viewable content in the previous version.

As mentioned above, the subsequent version of the content can be presented automatically, or in response to a predetermined action performed by the user. However, conditions can be implemented regarding when performance of the predetermined action will lead to presentation of the subsequent version. For example, to ensure that the user reads a sufficient amount of the current content before moving on to the subsequent version, use of the predetermined action to cause presentation of the subsequent version can be conditioned such that the subsequent version is not presented on performance of the predetermined action unless a minimum predetermined number of units of content have been viewed 12 by the user prior to performance of the predetermined action. This enables the author of the document to prevent a user from jumping ahead to the subsequent version prematurely, before having read (and purchased) sufficient current content.

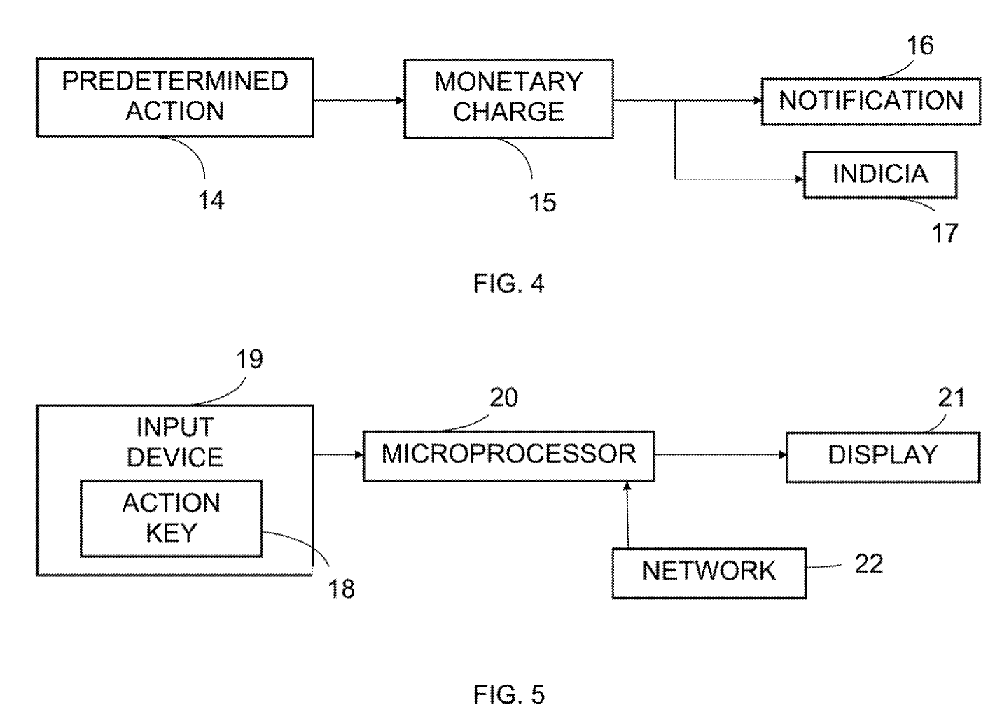

As shown in FIG. 4, the author and/or publisher of the document file can charge a fee for consumption of the content by the user by assessing a monetary charge 15, for example, for every consumed unit of content, or for every performance of the predetermined action 14 or other designated event. A notification 16 can be provided to the user each time the charge is increased, or is about to be increased, and indicia 17 can be provided to the user showing the total monetary charge incurred durng a session. The charge amount can represent an amount that the user will be required to pay, or an amount that will be deducted from a pre-paid account established by the user with the publisher.

The predetermined action mentioned above can be any action designated by the publisher that is able to be performed on the user's viewing platform. As shown in FIG. 5, if the content is to be presented and viewed on a conventional computer or other typical microprocessor device 20 that is in communication with the electronic display device 21 and which can be connected for communication via a network 22, the predetermined action can be the depression of a keyboard key 18, combination of keys, or series of keys, for example. If the content is viewed on a dedicated viewing device, such as a device specifically designed to view content provided by the publisher or by publishers providing content according to the method of the invention, the designated action can be actuation of an action key 18 on an input device 19, which can be designated specifically for this purpose. It is contemplated that any input action apparent to one of skill in the art can function as the predetermined action.

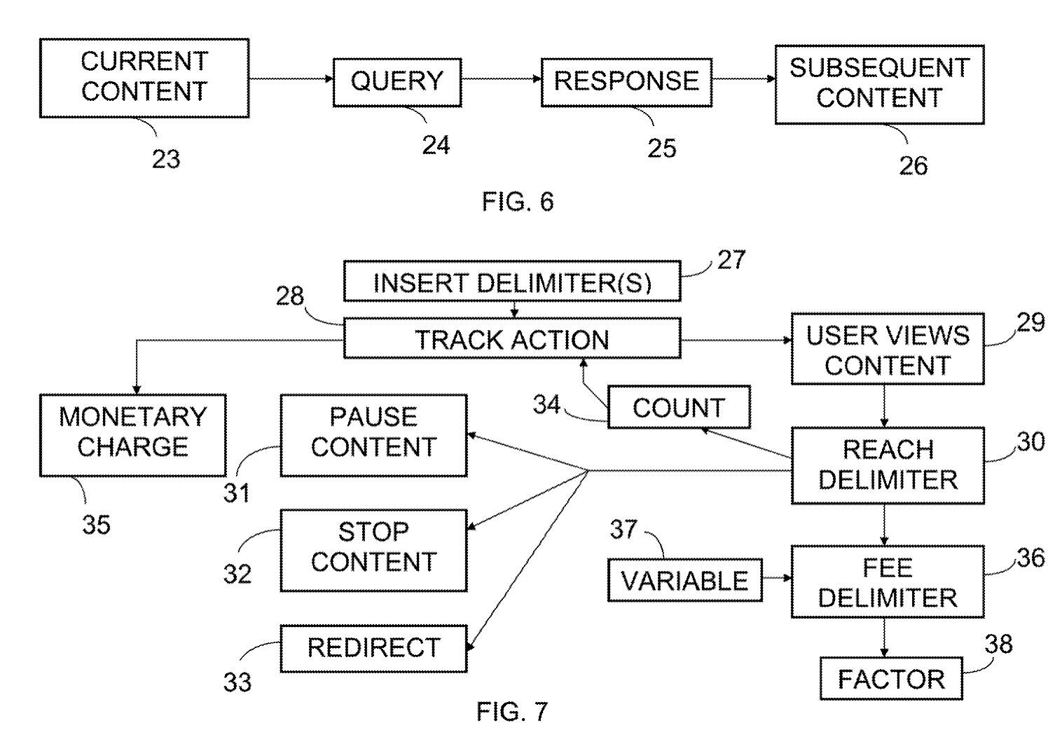

The predetermined action can also be interactive. For example, as shown in FIG. 6, after consuming a certain predetermined amount of current content 23, the user can be presented with a query 24, such as one or more questions related to the substance of content consumed to that point, to which the user must provide an answer 25. The predetermined action would be the correct response to a question, or to a great enough percentage of a number of questions. If this requirement is satisfied, the subsequent content is presented to the use 26. If this requirement is not satisfied, the action is not deemed to have been performed, and the subsequent version (for example, a version in which unviewable content following the end of the current content becomes viewable) is not provided to the user. If the requirement is not satisfied, subsequent versions of the content can be forever denied to the user, as an example of a harsh consequence. Alternatively, the user may be offered an opportunity to answer the questions again, to answer related but different questions, or to re-consume the content on which the questions are based before being given a new opportunity to respond to the query.

The content itself can include, but does not necessarily include, text. The content can also include still images, animation, audio content, or any type of media or data that can be experienced by a user, and the term “view” as used herein is intended to encompass any such receiving experience by a user. Thus, the document file can be, for example, a plaintext file, an HTML file, and/or an XHTML file, and the content can also include at least one data tag, which can include formatting tags, hyperlink tags, image source tags, sound source tags, video source tags, table tags, form tags, frame tags, style tags, div tags, class tags, embed tags, object elements, scripting programming language such as JavaScript®, multi-platform object-oriented programming language applets such as Java® applets, multi-media presentation software such as Adobe® Flash® units, and/or HTML5 units. The units by which the content is measured can be designated by the publisher to be of any size. For example, a unit can be designated to be a line of text, a sentence of text, a paragraph of text, an image, a chapter of mixed-media content, a string of data, or any other measurable quantity of content, text or otherwise, and once designated will consistently be considered to be a unit of content in the document. For example, if a unit of text is designated to be a paragraph, and content is presented to the user sequentially a unit at a time, then content will be presented to the user a paragraph at a time while consuming content in this particular document.

A “page” of text, which can be defined by the screen size of the electronic display device on which the content is viewed or which can be larger than the screen size and scrollable, is another example of what can be designated as a unit of content. If the content is provided via a network interface and is viewed by the user in a browser window, that window can also be used to define the unit size. Regardless of what amount of content is designated as the unit, content will be provided sequentially to the user a unit at a time. Any interleaved content that may be provided will also be provided in discrete units, arranged before, between, or after other units of content, but not within units of content, although units of content may be replaced by other units of content in subsequent versions.

As shown in FIG. 7, if the document includes a textual portion, one or more delimiters can be inserted 27 at a selected position(s) of the textual portion to define delimited content. For example, at a selected position, the textual portion can be occupied by a particular character combination that includes a delimiter. When the delimiter is reached 30 as the user consumes units of content 29, advancement of content can be caused to stop 32 until further action is taken by the user. Alternatively, presentation of content can be paused 31 for a selectable, discrete number of time units, and/or presentation of the document file can be automatically redirected 33 to a different location in the document file on reaching the delimiter.

Further, predetermined events and/or actions can be tracked 28 that occur while the user consumes units of content. For example, a number of delimiters passed by the user while viewing units of content, and/or a number of units of content passed by the user while viewing, can be tracked and counted 34. More than one type of delimiter can be used, in which case tracking the delimiters can include separately tracking the delimiters of each type or of one particular type. The number of units of content passed by the user while viewing can be tracked by tracking actions performed by the user that cause a subsequent unit of content to be presented, or by automatically tracking the end of a current presented unit of content for which there is no stop delimiter. In this way, consumption by the user of content can be tracked in order to determine the user's consumption data, for purposes of interest to the publisher.

For example, a monetary charge 35 can be associated with the tracked number of delimiters passed by the user, the tracked number of units of content passed by the user while viewing, movement of the action key, or any other tracked behavior. For example, each time a delimiter is passed by the user, or each time the number of units of content is passed while viewing, a total monetary charge can be increased. If the tracked unit of content is a string, a string counter can be incremented to track the number of units of content passed by the user while viewing, and the associated monetary charge is increased whenever the string counter is incremented.

A particular fee delimiter 36 can be designated separately from other delimiters, so that the monetary charge associated with the tracked number of fee delimiters passed by the user can be used to increase the monetary charge rather than the tracked number of units of content consumed. This fee delimiter can be variable 37 in such a way as to make the associated monetary charge variable, for flexibility in charging a user for consuming content. In order to provide discounts or to otherwise provide a different fee schedule for different users consuming the same content, the instantaneous monetary charge and/or a cumulative monetary charge for the user can be multiplied by a user-associated factor 38. The user-associated factor can be determined by, for example, the user's reaching content-consumption goals, or the user's performance of a task, such as a task related to answering questions regarding substance of the content.

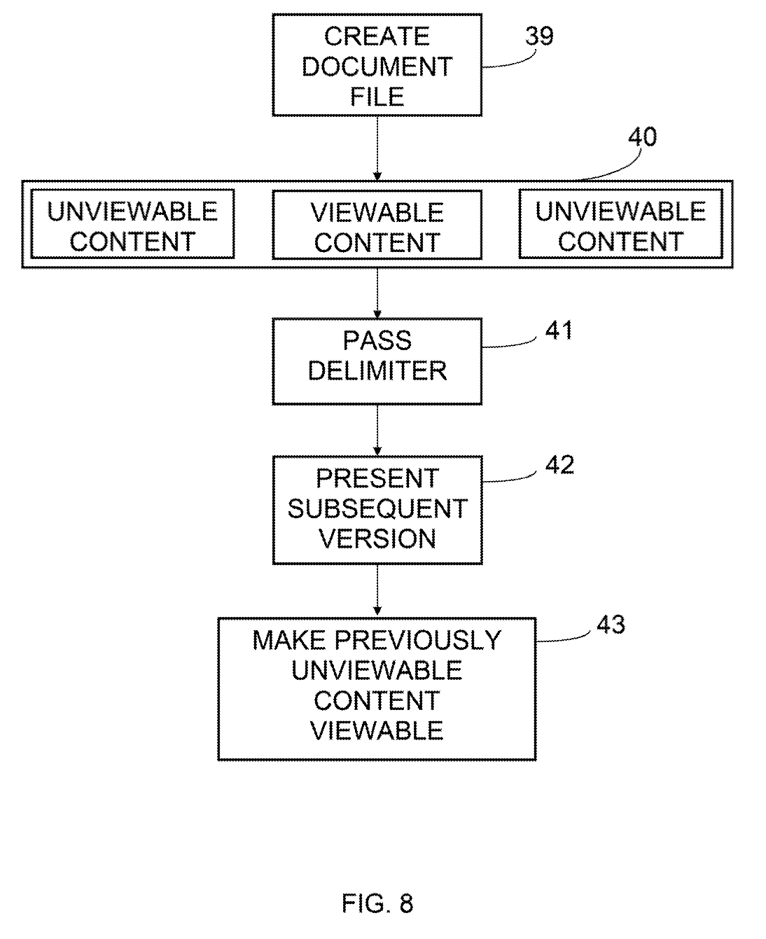

As shown in FIG. 8, the method of governing content presentation according to the invention can provide unviewable content to the user automatically, without user intervention. In this case, an author creates 39 the document file, and the author or publisher inserts at least one delimiter at a selected position(s) of the document file. Fewer than all of the units of this content are viewable by the user in a version of the content currently presented to the user. For example, unviewable units of content can be disposed 40 prior to the units of viewable content and/or after the units of viewable content. Units of content are viewed sequentially by the user. A subsequent version of the content is presented 42 to the user in response to passing 41 the delimiter by the user while consuming content. Now, at least some of the unviewable units of content in the previous version of the content are viewable 43 in the subsequent version of the content. Thus, presentation of the content from the current version to the subsequent version takes place automatically when the user passes 41 a delimiter while consuming the content. As a result, previously unviewable content becomes 43 viewable.

Cases in which subsequent versions of content are provided to the user on performance of an action or passing of a delimiter have been described. It should be noted, however, that these are not the only modes of advancing to a subsequent version contemplated to be within the scope of the invention, and the invention is not limited to these particular implementations. For example, a subsequent version of the content can be presented both without the user passing a delimiter and without the user striking an action key, particularly when the string that is being read changes, for example, where there is no stop delimiter in the document file.

Presentation of the content to the user need not be restricted to revealing previously unviewable content to the user in subsequent version(s) by adding these to the current version of the content. Instead, for example, the content can be presented to the user in two or more discrete versions in controlled sequence, as shown in FIG. 10. An original or current version of the content, in which units of the content are currently viewable by the user, is presented 51. The user performs a predetermined action 52. In response to performance of the predetermined action, a subsequent version of the content is presented 53. At least one unit of content that is included in the current version of the content is not included in the subsequent version of the content, and/or at least one unit of content that is not included in the current version of the content is included in the subsequent version of the content. Thus, on performance of the action by the user, a complete replacement version of the content is presented for consumption, in which at least some units of the content are added, removed, or otherwise different from the previous version. Again, discrete units of content are added or subtracted according to this embodiment; if content within a unit is to be changed, that unit is replaced in its entirety.

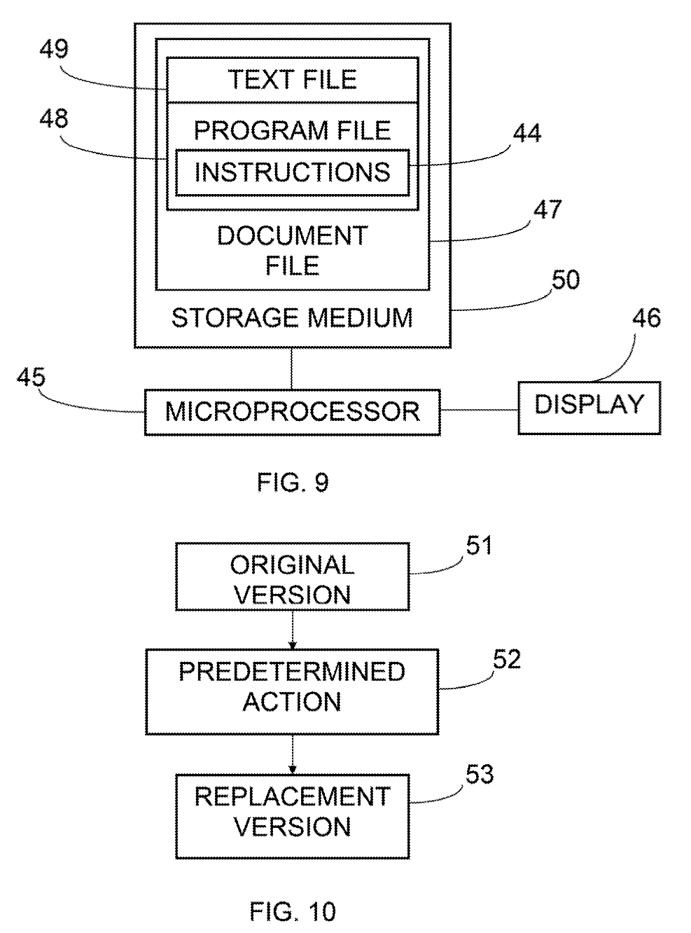

As shown in FIG. 9, the invention can be embodied as an integrated device that includes a storage medium 50, a microprocessor device 45, and an electronic display device 46. The storage medium 50 includes intransient instructions 44 in the program file portion 48 of the variable computer-readable document file 47. The instructions 44 can be implemented by the microprocessor device 45 to cause content to be presented to the user on the electronic display device 46 according to the instructions 44. The instructions 44 in the program file 48 allow the author to create variable computer-readable content as a text file portion 49 of the document file 47, for presentation on the electronic display device 46. The text file portion 9 includes viewable content and unviewable content, presentable to the user as otherwise described herein. The instructions 44 included in the program file 48 are a computer-readable instructions that preferably are largely unvarying and include previously programmed computer code allowing the document file 47 to be executed.

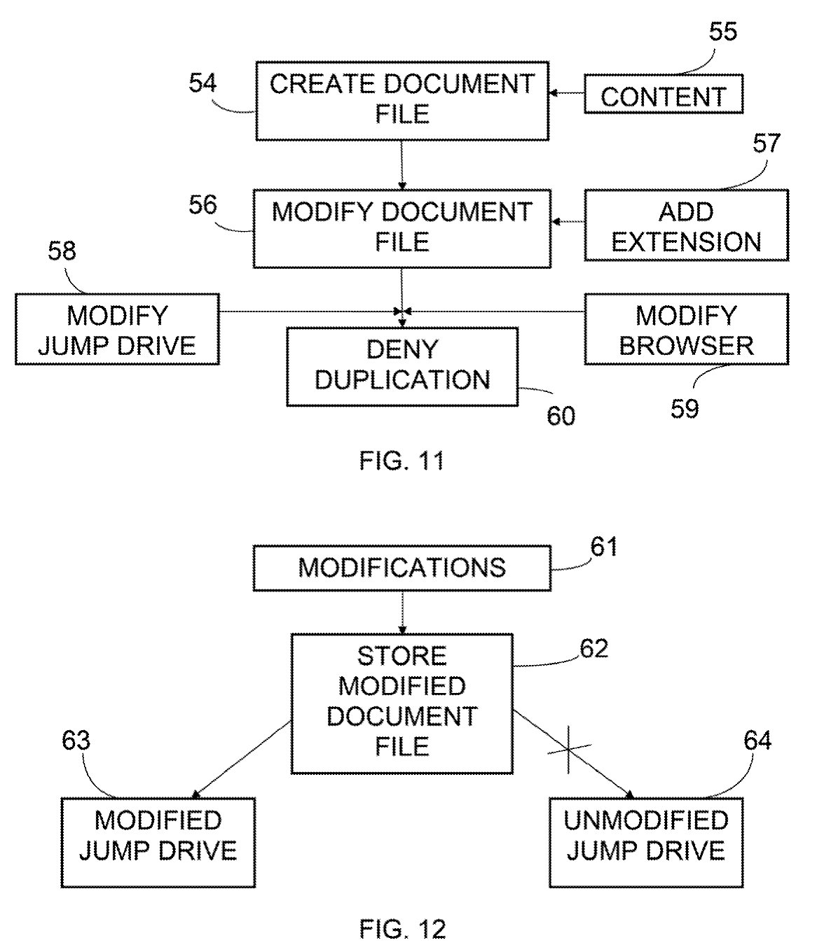

The present invention also encompasses methods of restricting or controlling the duplication, altering, and dissemination of document files. As shown in FIG. 11, prevention of unauthorized modification of a document file can also be provided when creating 54 the document file. As mentioned previously, the document file is a variable computer-readable file that includes content 55 for presentation to a user. A browser 59 acts as an interface used to present the content, and a portable storage device such as a thumb drive can be used to store the document file, to be accessed by the computer or reading device. The browser, an operating system 58 for the portable storage device, and/or the document file 56 can be modified as part of a duplication-prevention process. Modifying the portable storage device operating system, for example, can include restricting the portable storage device operating system such that modified document files stored on the modified portable storage device cannot be opened by other than the modified browser. The modifications to the document file, the portable storage device, and/or the browser can conjointly render the modified document file unable to be duplicated 60.

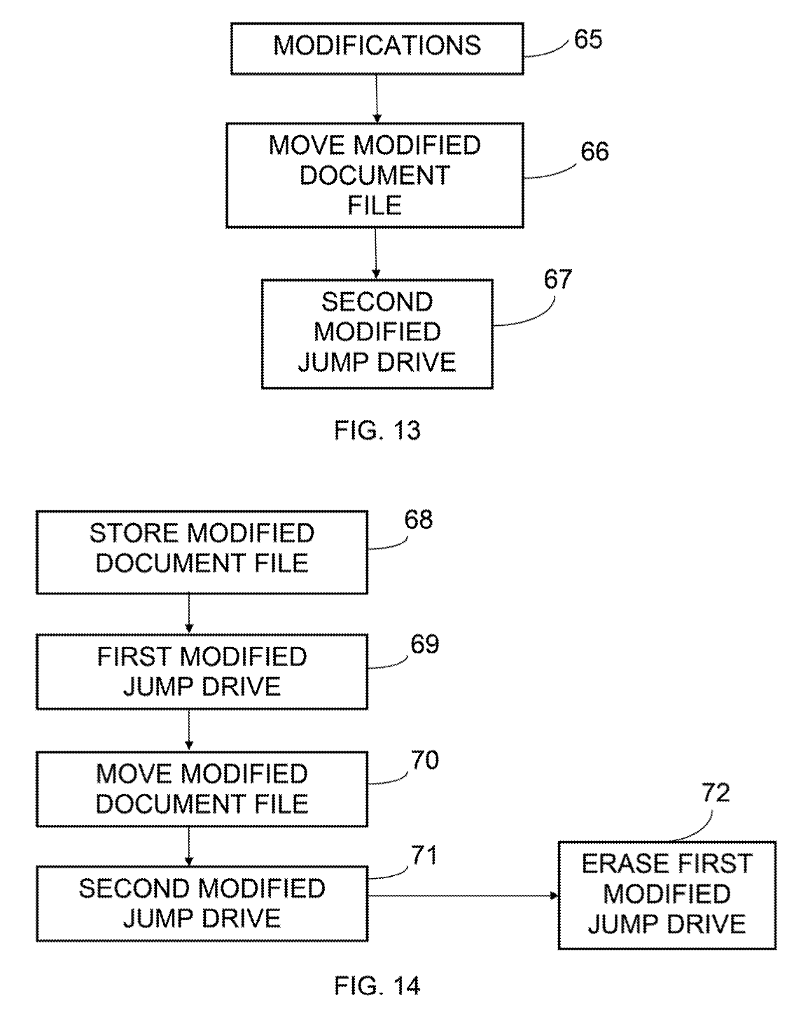

For example, the document file can be modified to include a designated extension 57. As shown in FIG. 12, the designated extension and other modifications 61 render the modified document file unable to be stored 62 except on a modified portable storage device 63, which is a portable storage device including the modified portable storage device operating system. The modified document file may not be stored on an unmodified portable storage device 64, that is, a portable storage device having a conventional, unmodified operating system. Other conditions can be imposed with respect to moving the modified document file. For example, as shown in FIG. 13, if the modified document file is currently stored on a first modified portable storage device, the modified document file can be moved 66 to a second modified portable storage device 67. However, the modifications 65 can conjointly render the modified document file able to be moved from this original storage location only if the modified document file is stored on a designated second modified portable storage device, and not on an unmodified portable storage device. As another example, as shown in FIG. 14, the modifications can conjointly render the modified document file able to be moved 70 from a first modified portable storage device 69 on which it is stored 68 to a second modified portable storage device 71 only if the modified document file is erased 72 from the first modified portable storage device, and unable to be moved to a different modified portable storage device otherwise. Thus, duplication and movement of the document file can be accomplished through modification of the document file and of the storage media on which the file is stored and the browser through which the file is opened.

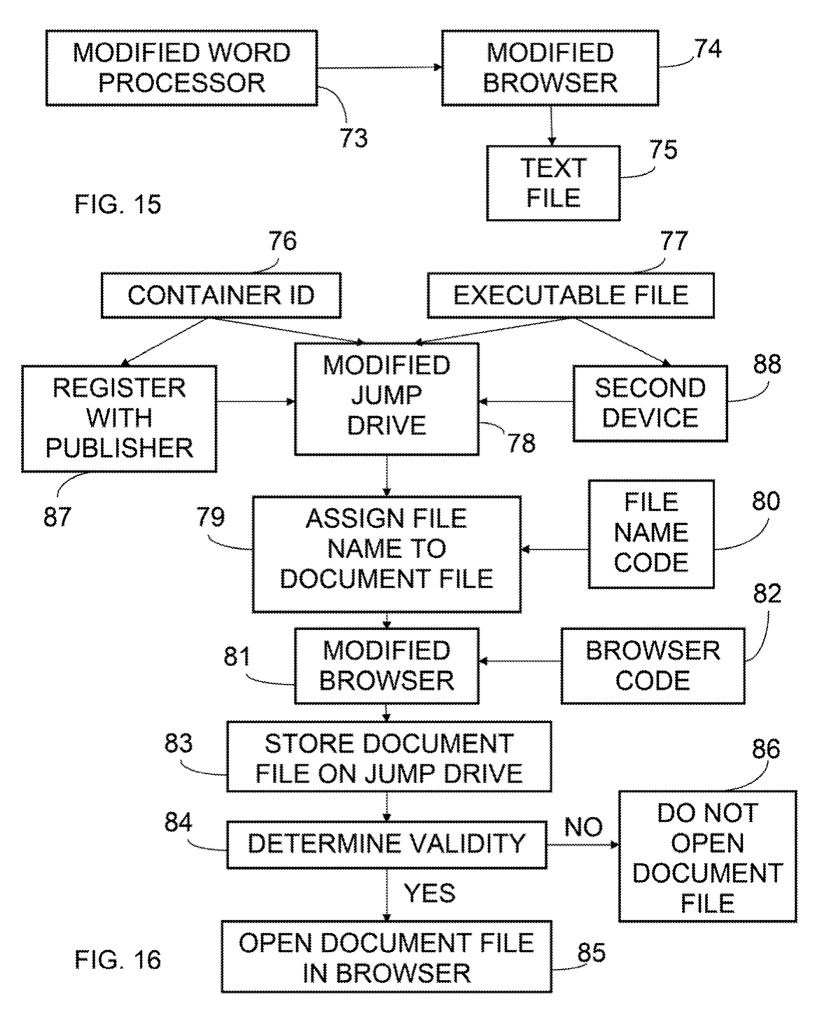

However, it is possible for the modified document file document file, stored on the modified portable storage device, to be altered by a user. The modifications can conjointly render the modified document file having the modified text file portion able to be stored only on the modified portable storage device. As shovwn in FIG. 15, the modified document file can be altered by a user by copying only a text file portion 75 of the modified document file using a modified word processor 73 that is configured within the modified browser 74. The copied text file portion of the modified document file can be altered using the modified word processor, and the altered copied text file portion of the modified document file can be stored using the modified word processor by replacing the text file portion of the modified document file stored on the modified portable storage device by the altered copied text file portion of the modified document file, and using the modified browser conjointly with the modified portable storage device operating system to store the altered modified document file. In this case, the browser can be restricted such that it can only open a text file using the modified word processor. Thus, alteration of a document by a user is possible, but is restricted to alteration using a modified word processor, and storage of the altered document file is also restricted.

As shown in FIG. 16, a container ID 76 and an operating executable file 77 can be stored on a portable storage device 78 associated with the modified portable storage device operating system. A filename is assigned 79 to the modified document file in which the filename includes a designated filename code 80. A designated browser code 82 is assigned to the modified browser 81. The modified document file is stored 83 on the modified portable storage device. An operating program associated with the operating executable file is used to determine if the filename code is valid, based on a predetermined criterion, and the operating program associated with the operating executable file is then used to determine if the browser code is valid, based on a predetermined criterion. A condition is applied such that opening the modified document file in a browser window by the modified browser 85 occurs only if the filename code and the browser code are both determined to be valid 84, and otherwise opening the modified document file is not allowed 86. The container ID is registered with the publisher 87. Thus, storage of the modified document file on any portable storage device, whether modified or not, having an unregistered container ID can be prevented. This functionality can be implemented using, for example, encryption, a hashing function, or any other suitable implementation, as will be apparent to those of skill in the art.

An executable file including the modified document file can be created at a first device and transferred from the first device to a receiving device. This receiving device can be a second device, or it can be the first device, such as when the first device is a node that is shared by two or more users. For example, the transfer of the executable file can be made via email, which can be received by a recipient at another device, or by another recipient at the same device, usually via a different user account than that used by the sender. The modified document file can be opened from the executable file only if the receiving device is communicatively connected to a portable storage device having a registered container ID. If this is the case, the modified document file is stored on the portable storage device having a registered container ID. Opening the modified document file if the receiving device is not communicatively connected to a portable storage device having a registered container ID is thereby prevented.

According to another aspect of the invention, two or more sets of string functions, for example, a PAAT set and a PIIT set, or one PAAT set and several PIIT(n) sets—where (n) is an integer greater than 1—will govern presentation of successive series of strings. This embodiment is useful for several reasons. For example, a writer might not want to be compelled to present exactly the same number of interleaves between each pair of pages, as he might be under certain embodiments described above. In addition, a writer using this approach can employ multiple different interleaf sets to present highly complicated and involved ideas or facts to a reader serially and progressively—at increasing levels of detail and sophistication, and/or refinement of ideas and argument—in consecutively presented sets of interleaves. In addition, a writer may want to employ differing rules governing backward progression, such as one screen at a time, or all the way back to the beginning, in certain different separate series of strings. Utilizing two or more different string headers corresponding to separate string functions will provide the additional flexibility in implementation.

The invention can be implemented through certain modifications being made to an existing Web browser, to an existing portable storage device operating program, and to documents as described herein such that these documents will bear their own unique extensions, such as “.N11,” in place of the current “.htm” or “.html” extensions. When these modifications are made, documents authored according to the invention are playable only from and storable only to designated pieces of digital memory equipment, such as USB portable storage devices (JumpDrive® storage devices, Memory Stick® data storage media device, flash drive, thumb drive, etc.) or other hardware storage token, or in an alternate implementation, from and to the digital memory of particular computers and cell phones, for example. Likewise, when these innovations are implemented, various rigid and at this time-point unexpected and unusual restrictions can be placed upon viewers' use of electronic documents that they possess. And likewise, a fourth “fee delimiter” can be employed by authors, editors, publishers, and later commenters to assess fees of viewers more or less proportionately to the viewer's use of the document.

A conventional portable storage device has its own unmodifiable and unique serial number imbedded in it, just as every computer has a MAC address. This serial number in a portable storage device can be considered the container ID. Assuming that a digital publisher issues unique portable storage devices for use according to this invention, which will hereinafter be referred to as “registered portable storage devices,” such drives are manufactured with, in addition to the regular container ID embedded on them, a stored special operating executable file to run the drive. This modified operating .exe file will include an “examine-alphanumeric-code-which-is-the-container-ID before .N11 file can be opened” function written into it. The possessor of such any such drive cannot use this drive to store, open, play, or reveal the source code of a document with an .N11 extension, except when this particular portable storage device is known by the publisher to be a registered portable storage device. This restriction is made possible particularly because of the special nature of the new Web browser, which can itself exclusively open, play, and show source code of .N11 files—this browser hereinafter referred to as the B-prime, or “B′,” browser—in conjunction with other features of this invention. This can be implemented through the use of codes verified by a hashing function, or through the use of another cryptographic function, as will be apparent to those of skill in the art.

A B′ browser can be used for security reasons, for example, in order to prevent a file with an .N11 extension from being opened and played and from having its source code revealed by any browser other than a B′ browser, and except where this .N11 file was already stored on a registered portable storage device. An existing browser can be modified in several ways to become the B′ browser. For example, it can be modified to permit the embedding of a unique code module, which may be an alphanumeric expression, at a designated location within its code. Further, it can be modified to “handicap” certain expected functions of a Web browser, such as the “open” and “show source code” of a markup language's file functions, so that these will not be executed unless certain preconditions are met. In addition, the browser can be modified to be able to check, at the request of the B′ browser itself, a continuously updated list (maintained by the publisher, for example in an online database) of registered portable storage devices that have been issued by the publisher, for the presence or absence of a particular container ID.

Thus, each .N11 file issued according to this method will be stored only on a registered portable storage device—or alternatively, to devices of a different, yet comparable electronic storage medium type, including ones not yet marketed and/or ones utilizing technology not yet invented, including proprietary types—and will include in its file name a unique alphanumeric code issued by the publisher. A “check-alphanumeric-in-file name” function of the jump-drive operating program will determine if this filename code is valid. Then, assuming that the checked code is valid, a second function of the jump-drive operating program, a “check-alphanumeric-code-in-the-browser” function, will examine the code alphanumeric that is located in the B′ browser program to determine if it is a valid B′ browser. Only if both preconditions are met will this .N11 then be opened by the B′ browser in a browser window.

When a file is opened in a B′ browser window, a handicapped “show source” function of this browser can reveal the source code of the .N11 file, but only if the browser has determined that a registered portable storage device is present in one of the peripheral slots (such as D:, E:, F:, G:) of the electronic device running the browser. To prevent a viewer from disabling security and payment features of .N11 documents, the text files and program files of .N11 documents can be made separable and the B′ browsers “show source” function handicapped so that only text files and not also program files will be revealed.

The operating program of a registered portable storage device will not allow the electronic device running the B′ browser to store any document on this drive unless the file has an .N11 file extension, and it will not permit storing of any .N11 file, including any .N11 files that have been altered by a user, for example, to include his own “marginal notes,” except on a drive whereupon an .N11 file with the same name is already present, and then only by overwriting this existing .N11 file. To stress and emphasize, the storing of documents by a viewer on internal computer memory media, or on external electronic memory media other than the registered portable storage devices here discussed—yet excepting devices that are similar to portable storage devices, where the publisher deems these to be “more advantageous” from its vantage point than portable storage devices—will be blocked by the publisher according to the invention.

Copies of the B′ browser are each assigned an alphanumeric code at the time of their installation on an electronic device. Such copies of the browser will be made available to users, for example by free download from the publisher's website. This browser will be programmed in a computer language that can be compiled into an executable file. Because this code will be compiled, it will be difficult or impossible to fraudulently reverse engineer, including by the inclusion of a fraudulently created browser alphanumeric code. Preferably, the algorithm used to generate alphanumeric codes, and concomitantly to determine whether alphanumeric codes that appear in .exe file names, .N11 file names, or individual copies of the B′ browser are “valid,” will be kept outside the public domain. Thus, efforts to fraudulently distribute electronic reading material in order to bypass the correct assessment of fees by a publisher will to an extent be frustrated.

According to this embodiment, individual copies of electronic books, pamphlets, articles, and other materials in electronic form will be available directly from the publisher's website after payment of a variable “maximum use fee” by each user. For example, a user wishing to obtain an electronic book or other materials will go to the publisher's website and log on there by providing his email address or other identifier and subsequently a payment method, for example, credit card account details. After log-on and provision of a payment method, users will be directed to separate web pages where a publication list is located. This list will indicate each item for sale, for example, at least by its title and maximum user fee. The maximum user fee will be variable, from free to any fixed maximum amount, at the publisher's discretion.

When the user has identified an item that he wishes to procure, he will obtain it by selecting the item name, which will be a hyperlink, and then in a separate screen, by selecting a radio button to confirm his purchase, thereby paying the listed amount and receiving an email message having the selected item sent as an attachment. This attachment will be written as an .exe file so that it will not exactly comprise the document representing the purchased item. Therefore, it will not exclusively consist of the respective .N11 file that is to be played in a B′ browser after storage on a registered portable storage device. Rather, the attachment will “embrace” the .N11 file, allowing it to be opened and the document contents immediately to be transferred to and stored on a registered portable storage device as the .N11 file, after certain preconditions have been determined to have been met. If out of security concerns, .exe files are not allowed to be opened directly from email attachments by, for example, antivirus software, corporate security policy implementations, or electronic-device operating platform measures, a storage step or other intermediate action will be performed.

Each item purchased from a publisher's website will be assigned, at the moment of its creation by the publisher's website program, a suitable alphanumeric code that will be present in the file name of the .exe attachment. Then, when the user opens this .exe from within his email program, it will be opened and immediately stored as a novel .N11 document on the registered portable storage device that is then present, upon certain conditions being met. For example, a registered portable storage device must be found on or in direct communication with the device that is running the email program. Whether this drive is thusly present will be determined by the B′ browser that has been designated to open the .exe, for example by examining the peripheral slots of the electronic device running the browser, first for the presence of a registered portable storage device, and second for whether there is a valid container ID number on that drive. Further, the attachment .exe file's alphanumeric code must be valid. Whether it is valid will be determined by the B′ browser. If both conditions are met, the operating .exe file of the registered portable storage device will disarticulate the .exe file attachment to remove the respective .N11 file, and thereafter store only the .N11 file under a file name that still will encompass the alphanumeric code of the email attachment, while also storing a copy of the original .exe on the registered portable storage device.

When a viewer attempts to store a modified copy of any .N11 file, before it can be stored the operating software on the registered portable storage device will compare the modified version to the original .exe itself, specifically in order to determine if any fee delimiters, either any ones in a string prior to, or alternatively “forward of the last-read string,” have been removed during editing of the new .N11 version—the version that the viewer now hopes to store. This will be done so that correct payment for use of the .N11 cannot through such means be avoided by a viewer. Only if no relevant fee delimiters have been removed can storage of the new .N11 version occur, replacing the old version.

Multiple .exe attachments may be disarticulated, reconstituted, and stored on a single registered portable storage device, making it in effect a “library” for all of those .N11 documents. Preferably, at the time of purchase, all .N11 documents will exist in a single copy. If a user chooses to place multiple .N11 materials on a single drive, he will be unable to loan these out singly, as individual items. Regardless of whether he stores many .N11 materials on the same drive or only on respective multiple drives, he will have but one copy of each, whether this copy is annotated or clean, to keep or to loan out, unless he opts to purchase multiple copies of any .N11.

The operating executable file of the registered portable storage device will allow an .N11 file to be erased from one drive while simultaneously being stored to a second drive that is present in another auxiliary slot, so as to allow files in a library that is present on a single drive to be loaned out while the overall library is retained, and to allow these loaned files to be returned in a similar manner. That is, a cut-and-paste functionality will be implemented, rather than a copy-and-paste functionality. Alternative embodiments implement use of an associated log file to facilitate and record such transactions. Any such log file can be used to determine loan duration for purposes of, for example, billing.

If a publisher wishes to charge users to read .N11 items, he will have a novel means by which he may do so according to an embodiment of the method of this invention. Through use of a fourth delimiter type mentioned above, the publisher will be able to charge a varying amount, from no fee up to an indefinitely large fee, each time the user passes such a delimiter (under certain circumstances, a user will be paid to read an .N11 item, in which case negative fee amounts will be incurred). The publisher who utilizes such an approach will store on the registered portable storage devices he makes available a second .exe file, or other compiled program. This .exe file's function will be to maintain an account for the user with respect to this publisher. When a user acquires .N11 items, his maximum use fee will be stored into individual variables in this account .exe file on the registered drive. When a user reads one of these items, as he passes a fourth delimiter, the amount in the .N11 item's amount variable will be decremented according to the fourth delimiter in question, where accounts are pre-paid. Of course, other payment schemes, such as credit models, may be used, in which case the amount variable can be incremented.

In a case in which a computer program devised according to the method of this invention does not permit delimiters such as the fee delimiter meaningfully to be interpreted by the CPU except where they are encountered through the viewers pressing the “regular” interleaf-skipping advance action key, in this example the right-arrow key, the author can make certain sets of modifications concomitantly in the program file and text-file of a document to work around this limitation.

As a non-limiting example, the author can code for a “redirect key” or “redirect keys” similar to the left-arrow action key previously described, through modifying the program file of the document. Such keys when pressed can direct a reader to the first string of a special section of the text-file which can preferably be placed beyond the end of the remainder of the document. In order to permit delimiters in the interleaf screens of such a section to operate correctly, the author can first code for an unusual pair of action keys in the program file, and second insert a “numerically correct” number of true interleaves (which themselves may be blank, for example) between each pair of the author's intended “meaningful” interleaves—these meaningful interleaves being, actually, in this instance pseudo-interleaves. The particular pair of action keys here described preferably will be forward and back keys which when struck, will direct the CPU to skip that number of strings in the text-file corresponding to the number of interleaves encoded for in the program file of the document in general, multiplied by the number of pseudo-interleaves interposed between every pair of main pages in this particular section.

Readers when wishing to view interleaves, either before or after any of the main pages in this section, can first position themselves appropriately using the special forward and back keys particular to the section, and then utilizing the document's main, regular “forward action key” as employed elsewhere in the document, skip forward from the string representing one such pseudo-interleaf in this section to the next.

However, in a preferred implementation of the invention, where this approach is employed by an author, all delimiters including fee delimiters that are emplaced in main pages or in pseudo-interleaves in the special section will not “operate.”

If the author wishes it, where more than one such section is to be employed within a document, among them these sections may utilize different constant numbers of pseudo-interleaves between pairs of main screens—it only being required for this to work, that appropriate sets of special forward and back action keys be programmed for in the program file and that in every respective section, the correct constant number of pseudo-interleaves be interposed between every pair of main screens.

When this approach is used by an author, a method can be employed to return the reader to the point from which he had departed, preferably through the reader's pressing a designated “return key” once the end of such a special section has been reached. This method may also be automatic, preferably with a note to the reader occurring suitably and automatically to inform the reader how the “rules of engagement” within this special section are changed—particularly meaning for instance, which two action keys are to be used in the section as forward and back keys, and that in the section accessing interleaves might not be free to the user.

Assuming that a user chooses to stop reading before finishing an .N11 file, he will be able to close and re-open this file, and to read up to this point as often as he likes, without incurring further fees. If he chooses to read beyond that point, however, he will incur further fees, and the amount variable for this .N11 file will be decremented according to the method of this invention.

In an alternative embodiment, one or more designated points in the document, for convenience hereinafter called “Go points,” can be authored into the text file of an .N11 document. These Go points can be used as control-access points, to limit the reader's access to a page or pages of content occurring after the Go point. For example, it can be the case that a reader, once his forward progress has been paused at a Go point, will opt to go beyond it, further into an .N11 document, by pressing the “ordinary advance key,” here now to enter what will be referred to as an “infra-leaf section,” which may be one of several such infra-leaf sections, comprising a simple page or pages of content, or comprising a page or pages of content up to all of which will be “interleaved.”

At a Go point, a warning box or other notification may be displayed on the screen informing the reader that after that point, all ordinary advance-key presses and/or presses of other action keys may incur a fee.

This capability allows a publisher to assess fees not only for consumption of interleaves, but also for the consumption of infra-leaves; so, a reader may incur charges for consumption of any or all matter presented after some certain set point in an .N11 document, regardless of the action key that is pressed and regardless of whether any meaningfully readable delimiter or delimiters are passed within the infra-leaf section. At the author's preference, when the user presses different individual action keys from within an infra-leaf section, he will be assessed different fees.

All or some sections of an .N11 document can also occur as “pre-leaves,” or that is to say, pages that will have been skipped over by the reader quite invisibly (excepting as they will have delayed the presentation of the normal first page infinitesimally) before he or she had reached the normal first page, or as pages that were not present in a previous version but are now present in the current replacement version.

Pre-leaves can be provided free of charge to the reader, or they can be provided concomitantly with the assessment of a fee or multiple fees—in the latter case, the magnitude of which can depend on the exact extent of the consumption of content by the reader, such as through a fee being assessed for every individual action key press.

Pre-leaves can be presented on the reader's pressing a “back to the hidden beginning” key, or—in an alternative implementation in which the end of a document will comprise a Go point—upon his pressing the ordinary advance key.

If a user affirmatively decides that he will not read further in this .N11 file, he can communicate this to the publisher or the publisher's agent in a manner that was previously designated as a mode to obtain a refund or credit. For example, he can send a “refund email” to a designated email address maintained by the publisher, sending this from the account from which he had purchased the corresponding .N11 file. He will attach to this email a file that will have automatically been created using an executable file that is present on all registered drives. This executable file, when invoked, will create a transaction file having as its file name the complete name, including alphanumeric code, of the unfinished .N11 file, and including in encrypted format the name of the respective amount variable, the alphanumeric code representing the respective registered portable storage device, and the number that is in this amount variable at the time of this file's creation by the executable file.

In an alternative implementation intended to prevent a fraudulent refund request from being mistakenly granted by the publisher, in the refund email the current .N11 copy will be automatically included as an attachment Then when the refund request is received by the publisher, this version will be compared against the original executable file corresponding to it, which will be retained on the publisher's server, to ensure that the .N11 copy is intact and uncorrupted, and particularly that fee delimiters have not been removed.

At the time of the transaction file's creation, the respective amount variable on the registered portable storage device will be re-set to zero. When such a “refund email” correctly bearing all requisite attachments is received by the publisher—for example, if a viewer's version of the .N11 file is attached, and this is subsequently found by the publisher to be intact—the user's account, such as his credit card account or a deposit account, will be credited the amount remaining in the amount variable (possibly reduced by a predetermined transaction amount)—where the checking of the attached .N11 file and the determination of whether a refund is appropriate can be carried out by an automatic “server-side” program that will be maintained by the publisher, or by the publisher manually, or by it automatically with the possibility of manual override. Subsequently, the user may open, read, and modify his own copy of this .N11 file as often as he likes, yet may not go beyond the point at which he previously stopped without logging back onto the publisher's website and increasing the amount variable for this file, to cover the maximum fee he might pay while reading the remainder of the file.

Similarly, if a reader has been able to complete an .N11 file without the amount variable for this file having been brought to zero—perhaps because he or she carefully and intelligently answered questions that were posed by the author as a pre-condition for reading more of the .N11 file—this reader can also send to the publisher such a “refund email” to obtain a partial refund of the maximum fee for the .N11 file. Any other type of reward offered by the publisher for correctly answering questions can be redeemed in a similar manner.

The amount variable may be decremented precisely by the amount dictated by that fourth delimiter, or it may be decremented by an amount equaling the delimiter amount multiplied by a real or particularly a rational number that will be the current score multiplier. In .N11 materials published under this approach, the value of the current score multiplier, after initially being set to a value of 1, will vary according to a formula at the publisher's discretion, for example, as dictated by the users scores on questions that he will intermittently be required to answer while reading this .N11 document, before being permitted to proceed.

As indicated elsewhere, such questions are preferably directed to material that a user should know based on what has already been presented in the .N11 document. Alternatively, the questions can be directed to information that has not been discussed, yet which someone who is qualified by reason of training to read this particular item should know or be able to infer. Still alternatively, the questions can be irrelevant both to the material covered in the .N11 document and to the relevant topic field. In this case, for example, questions might be posed merely to slow a user's progress, and for no other reason, or they might be posed as a method of “fairly” allocating cost, inasmuch as readers with more wealth or more indifference to spending on an .N11 item may more gladly answer questions indifferently simply to be able to continue reading uninterruptedly, while others with less wealth or more available time will scrupulously answer the questions to keep their costs low. Alternatively, if an author wishes to slow allocation of installments of a newly published .N11 item—mimicking Dickens's “serialization” approach, perhaps to draw out the time that a reader will have to contemplate and draw connections among information he had been exposed to—all of the questions might be quite impossible to answer until a certain day. For example, the question might be related to a particular event that has yet to occur, but will occur with certainty to yield a particular “digital-format” result at a particular future time—similar to an honest version of the old “Harlem numbers racket approach.”

According to a basic implementation of the present invention, one which does not involve the use of interleaves and which will permit forward and backward movement through a modified document one page at a time only, it is possible for the publisher's final edited version of a manuscript to be presented and for the writer's last draft to be presented beside it, so comparisons between the two by interested readers may be made. Preferably, the two documents will be coded within a single string in three distinct, yet ultimately geometrically overlapping CSS div elements, the second and third separated from the first and second by means of a delay delimiter or a stop delimiter.

Without a delay delimiter or a stop delimiter being emplaced between divs within a string, the transition from one div to the next in files created according to the invention can occur practically instantaneously. This feature of such programs allows “CSS formatting shifts” and especially the automatic addition or deletion of annotation material such as annotation boxes to occur many times faster within a line than when the CPU reading frame moves from one string to the next automatically, following the final delimiter in a string, when non-interleaf .N11 material is being displayed.

In thusly formatted materials, the second div element in a string can always be formatted to overlap and conceal the first div element, and the third to overlap and conceal the second, etc. Where through this method edited materials are presented “side-by-side” with the writers final draft, the first CSS div element in a string will encompass the authors final draft, while the second will comprise a two-color or similarly marked-up final edited version, and the third, a monochromatic, un-marked-up final publisher's version. Multiple other similar approaches to present the author's and editor's versions side-by-side are possible. In an alternative implementation, two or three successive strings may be used instead of one string.

In cases where within a string or between consecutive strings CSS shifts have been emplaced without a stop delimiter being emplaced and/or with there being only a “too-brief” pause delimiter between the elements, according to the invention a motivated reader can create an altered copy of his copy of the .N11 document to include a new stop delimiter before any “non-stopped” element in order to allow this to be read more easily thenceforward. Alternatively, a reader can employ the modified word processor function of the modified browser to read the raw text-file without storing an altered version.

Other schemes for marking up edited text can be used within the spirit and scope of the invention, as will be apparent to those of skill in the art.

Particular embodiments include means by which any reader can usefully annotate his or her own copy of an .N11 document and publish it as an “original document plus addenda” through the publishers website. For every “original document plus addenda” that is sold, the original fee will still be paid automatically to the publisher, and in addition some other amount—which can be a multiple of the original fee amount that can be equal to, greater than, or less than the original fee amount for the original document—can be paid as an “accessory” fee to the commenter.

Preferably in such a case, commenters will have an expert background or only sound insight according to some objective criteria, although neither of these will be necessary, unless, for example, so dictated by a publisher who opts to “pre-screen” comments to approve or disapprove of their addition to an existing document. A number of commenters can contribute in succession, all of whom will be paid what they originally would have been paid, each time the original document is sold with their respective comments added on. It is contemplated that commenters can take a good .N11 document and improve it, and also that they can take originals that have less value and make them more saleable.

Thus, the amount that authors and commenters can earn from their work will depend not only on the quality of their work, but also on factors that will initially be indeterminate, such as demand even after multiple “unexpectable” rounds of commenting. Publishers, therefore, will be able to establish a protocol by which the price of the original work and prices of additional components can be modified later. These price modifications can be made by the publisher at will, and/or by the publisher, author, or subsequent commenters, by individual agreement or, for example, according to an algorithm, or as otherwise set up according to the publisher's preference.

.N11 documents can be published in which, prior to every page seen by readers on a normal first read-through of the document, there will be an interleaf that will be identical to the normally seen page; so this identical interleaf page can be accessed by a reader from the normally seen page through pressing a back-one-page-at-a-time key from the normally seen page, only one time. Alternatively and equivalently, such identical interleaf pages can be present after every normally seen page, so each identical interleaf can be accessed through the reader's pressing a forward-one-page-at-a-time key, only one time. As well, such identical interleaf pages can be placed before and after each normally seen page.

Where an identical interleaf was inserted by an author before, or after, each normally seen page, readers taking notes can easily retain a clean and unmarked “reference version” of every page even where they wanted to “edit” or take notes on the normally seen pages.

To generate such documents, an author makes simple changes to the program file of the .N11 document in order to increment the number of interleaves that will be automatically skipped each time the advance key was pressed by one, while simultaneously duplicating each string and placing it appropriately in the text file, immediately before or after, or both, all of the normally seen pages. Readers can, as has been indicated elsewhere herein, make notes on or more extensively edit pages they were reading through opening the source code of the document and then modifying the string representing that page in a text editing program—here doing this either with the string coding for the normally seen page or with the string coding for the corresponding interleaf—before saving the revised document under its original .N11 document name on the same registered portable storage device where it had originally been stored.

Such interleaf pages at the reader's discretion might be kept “forever clean” for ease of reference, or they might be kept “clean” only for a while, for example in order that the reader could return to the original document later on to record new ideas such as ones that might occur to him merely with the passage of time, or otherwise through a second reading, in an alternative implementation, identical sets of interleaf pages might be emplaced in order that a second commenter's, or various “second commenters',” ideas could be recorded in the same document in addition to those of the original commenter.

The author can make the number of interleaves that will be present between every pair of normally seen pages vary from none or one, to any arbitrarily large number—this accomplished through the author's making simple changes to the documents program file while appropriately duplicating every string representing each normally seen page a desired number of times, and placing the correct number of identical string copies before and/or after every normally seen page. When reading such an .N11 document after modification, any reader will be able to access all of the edited pages by pressing the back-one-page-at-a-time key or the forward-a-page-at-a-time key, as appropriate, a suitable number of times.

If in the text file, the author wishes to increase the number of “clean pages” that are available for modification by readers, this can be accomplished by inserting complete duplicate sets of original pages, plus interleaves, at some point or points in the text file. Through making suitable additions to the program file, the author can allow a “first user” and then potential future users of an original document or a user-modified document to use special action keys to toggle between the alternate versions.

If the reader and not the author is the one who wishes to expand opportunities for comment, the identical approach may be used. The reader can, without needing to open the program file to modify it, that is, by relying on pairs of “toggle action keys” that are already in existence and emplacing any new “commentable” sections at the appropriate place after the end of the original text file.

Where an author might wish to allow individuals who had read up to a certain point in a specific .N11 document—however, only those and no others—to access a related “secondary”.N11 document, he can achieve this through placing a hyperlink at some point in the original document, which when the hyperlink is activated will automatically open a form that will allow transmission of an email containing the respective coded .exe attachment directly to the reader's email account—as similarly discussed elsewhere herein. According to this method, such .exe attachments can never be decoded other than by a B′ browser and moreover can neither be decoded nor stored except to the same registered portable storage device on which the original document was stored.

In an alternative implementation of the invention, an author, an editor, or a later commenter can record on paper his pertinent thoughts and ideas, insights, criticisms, qualifications, elaborations, further details, and further explanations that had not been presented in the “main-page” material itself, and which it was felt readers might want know after reading the respective main-page material.

Such notes are scanned as images in order to be placed as an “img” file at an appropriate point, such as through the Cascading Style Sheets formatting feature of HTML. Preferably, notes are set off from the text of the main-page, for example through use of paper of a different color than had been used in the main-page. Annotated pages can be inserted directly after or directly before the respective main page, as interleaves, for example.

Alternatively, notes, instead of being included in a document as interleaves, can be included in the same string that was coded for the respective main-page, for example at the end of it, after a stop delimiter.

Notes can be recorded in cursive, printing, or block letters, and can be by intent legible, less legible, or completely illegible. Notes also can be presented in the form of sketches, diagrams, graphs, formulas, equations, and the like. Any verbal or non-verbal type of note can be used. If material is not easily readable by viewers, such as by the design of its author, a “translation” of it can be offered optionally in a separate interleaf, for instance after the payment of an additional fee by the viewer.

Notes can be presented in shorthand. When shorthand is used, the shorthand system that is used can be a conventional system of shorthand, or it can be a non-conventional and obscure system, which is not easily readable by the uninitiated. Also, note material can be typed.

Notes can be augmented with further handwritten amendments, emendations, or corrections, or other editing—where such can be made by the author of the note himself, or by an editor or a later commenter.

According to another aspect of the invention, an author who has created a single- or multi-screen document can using ordinary word-processing software make one or more secondary copies of this version that differ from the primary version and between each other in one or more places in terms of word choice or phraseology, inclusion or omission of words, passages, paragraphs or sections, inclusion or omission of special CSS-formatted boxes or html-formatted sections, in terms of the color of highlighting or the presence or absence of highlighting, and in terms of the text color, text size, font style, bolding, or italicization of single words or groups of words or of passages, paragraphs, and sections. As well, secondary versions can differ from the primary version and from each other in terms of the background color of the page. Secondary versions can have “empty strings” added at their beginning or end but preferably will be of the same string-length as the primary version. Such secondary versions can be placed in the text file of the .N11 document, preferably in sequence and in register.

In .N11 documents employing this approach, pairs of back-and-forth toggling action keys and individual “skipping-action keys” can be coded by an author in the program file. In a preferred embodiment each one of a pair of toggling action keys would increase or decrease a reading frame variable as defined in the program file by a constant amount equal to the number of strings in the primary and secondary versions. By pressing one and then the other such toggling action keys, a reader could toggle between two or more versions of the same screen, in-register in different bits. By pressing a skipping action key a reader could cause his current reading frame to be redirected to a string elsewhere in the same version or in a different version—including to the same string where he had originally started out.

Some in-register matched screens in different bits cannot differ between one another, whereas others can. In-register screens can differ merely in terms of word choice or can differ much more broadly.

New information can simply be added between words or at the end of a line, or can be made to stand out in various ways. New paragraphs can be added between paragraphs using various formatting features of html.

If the interleaved document is a simple factual document such as a conventional piece of news reportage, the more complicated strings can present facts that the primary, basic strings in the group have not. As another possibility, if the .N11 is a theoretical or disputative work of an academic or political nature, the more complicated strings can present a variety of contrasting or complementary ideas and arguments that the most basic strings do not. The more complicated versions can qualify or can further explain concepts that the basic version simply presents. Where a work is fictional, somewhat similar approaches can be used.

A publisher can enable readers who are concerned about losing a registered portable storage device to store a backup copy of .N11 documents with a registered escrow agent and to store revisions that they may make with this agent as well. Fees can be assessed for storage of a backup copy and for downloading a replacement version, as non-limiting examples.

A publisher can alternatively refuse to allow a registered escrow agent to be used. Perhaps especially in this case, the publisher can offer specially designed hollowed-out books for sale, the hole in whose pages would exactly fit a portable storage device.

According to another aspect of the invention, electronic books can be created so that in sections of these, the author can employ variable delay delimiters to slow the turning of pages, while elsewhere in the document, he can take advantage of the near-instantaneous page-turns afforded under the invention. Also, the author can reverse the order of strings while not emplacing stop or delay delimiters in a section of the text file, so the pages will be presented “backwards” quickly one after the other, so the reader will have to use a “back one ‘interleaf set’ at a time” action key to read them.

According to another aspect of the invention, publishers will be enabled to charge for consumption of a page of an electronic book “in real time” as the work is being consumed.

As discussed generally above, publishers are enabled to assess per-unit fees variably, where either of two things may be meant by the term, “variable”: (1) fees that are discretely variable per electronic unit consumed, where each fee will be determined as a constant integer, decimal, or fraction by the publisher for any and all readers; or (2) fees that start from a predefined-by-the-publisher variable base and then are incremented or alternatively multiplied according to a formula to yield a fee for the consumption of the certain unit by a reader.

It should be apparent to those of skill in the art that, through simple modifications, a publisher may make “multipliable” copies available to institutions for their subordinate sale, rental, or lending, such as by libraries to patrons or by schools and universities to students, or in other situations in which group dissemination of a work is contemplated.

For example, such modifications could involve the forwarding of a list of recipient individuals' email addresses, registered portable storage device alphanumeric codes, and B′ browser alphanumeric codes to the publisher by the institutional buyer, for example through a secure website interface that is maintained by the publisher for this purpose. Terms are set forth by the publisher for, or an agreement between the publisher and an institutional buyer is reached as to, per-resale, per-rental, or per-borrowing costs for any multipliable document; likewise, terms are set forth by the publisher for, or an agreement between the publisher and an institutional buyer is reached as to, the percentage of the ordinary and regular .N11 document's “use assessment charges” that will accrue to the publisher on the one hand, and to the institution on the other. The publisher's portion can be added to a base fee that may be levied on the institution for acquisition of the multipliable copy.

Through simple modifications, a publisher may absolutely enjoin on a temporary basis, or in journalistic parlance “embargo,” readers from utilizing an .N11 document that logically is subordinate to a simpler “index electronic document,” which at the publisher's preference may be published as an .N11 document or as another sort of electronic book, or as a simple web page.

In an exemplary embodiment, a single- or multi-page news summary of some recent event is made available free of charge, or otherwise for pay, on-line to all potential readers, through the website of a news organization maintained by the publisher.

This index document in some part may contain one or more links to relevant, more complex, subordinate .N11 documents; but under the terms of this embodiment, such links for the term of the embargo are not accessible to embargoed readers. For example, in such cases, through clicking on the link in an index document embargoed readers can be redirected to a dead, temporary “wrong link” by the publisher working within the control panel of its website host. As a non-limiting example, such temporary wrong links can be associated with a relatively meaningless website having content that does no more than notify readers of the embargo and its duration.

When the embargo and the redirected link action are removed, thereafter any de-embargoed link or links will function correctly—so when one is clicked on by a reader, it will take that reader to the URL originally designated by the author at this point in the index document.

In another embodiment of the invention, readers in addition to being charged a fee when passing a fee delimiter in the delimited portion of an .N11 document may be assessed a constant fee for each keypress of one or several action keys, according to the programming of these keys in the program file of an .N11 document. To effectuate this charge, an action key or keys can be created in the program file so that when the key or keys are struck, in addition to the reading frame of the document being changed through alteration of the value of a currentIndex variable, a fee variable pertaining to this action key or to a joint set of such action keys will be incremented by one.

According to another embodiment of the invention, certain individual and within-themselves complete .N11 documents may be authored so as to embody “mathematically soft embargoes”—embargoes against the readers changing the reading frame within the document through depressing an action key, nevertheless which embargoes through modification of the program file by a publisher will be made “clock-dependent” in such a way that over time, the reader's fee for pressing the action key will by a mathematical formula or program be decremented.

The mathematical formula or program may embody a variable or variables the current value of which will depend on reader action—as a non-limiting example, the value of such variables depending on the reader's answers to one or more “ongoing test questions” that will be posed to the reader regarding the text.

Overall, the method of the invention without modifications can be used to limit the probability that “contextualized content” will be viewed by members of the general public outside its proper context, through a “logically secondary” component of the content only appearing within a document that is published according to the invention one or more pages after the respective “logically prior” component or components has or have been presented—whether or not users' comprehension of the logically prior component will be tested under another aspect of the invention as a pre-condition of being allowed to proceed to the logically secondary component.

In the news-publishing industry, when a news article or a feature has generated sufficient interest to justify the preparation of a follow-up article, the method of the invention can improve and can transform such coverage.

For example, when an item published by an electronic news organ under this invention is seen as meriting follow-up, instead of—as at present—the editor dictating that a fresh article must be reported and written to advance the story, this which will have to have its own fresh lead, yet at the same time by the nature of journalism itself, will be unable to correct very many factual or narrative errors in the original coverage—under the present invention editors can now assign an update that will advantageously replace the prior published version.

Replacing the prior version can mean, for example, adding comments to pages of the initial version as annotations to the original version, particularly on interleaves; partially or fully revising pages of content whether or not with the concomitant presentation in the updated version of the earlier pages, particularly as interleaves; and adding new pages or new sections of content for instance as “temporal after-leaves” in the updated replacement version. Any such features, or other features as described herein, can be used to permit new information to be presented to users, to permit prior errors of fact or interpretation to be corrected, and overall to more accurately interpret events and to more accurately put those events' meaning into context.

By utilizing a suitably defined CSS div within a string following a stop delimiter, yet without further stop delimiters being emplaced within this string, an author can allow a near-duplicate version of the content to cover over the initial content, as an overlay, in such a way that one or more superscript letters, numbers, or other keyboard characters can be seen by the user upon returning to this string by employing a specific action key from another point in the document.

These numbers, letters, or other keyboard characters will represent the action key or keys that must be pressed to access a plurality of pertinent fields of annotation matter elsewhere in the document, such as in an interleaf or a section of interleaves, or a group of interleaves interconnected by other suitably defined action keys.

Alternatively, in the overlay, and preferably only in the overlay, will duplicated characters, words, or images exist as, and/or be apparent as, hyperlinks.

And alternatively, through suitable definition of a DIV that is used to form the overlay, a “tail” can be added at the bottom of the overlay, and in this tail, and preferably solely in this tail, can notes, footnotes, comments, hyperlinks, and/or action keys pertaining to the original page be presented by the author or editor, or a later commenter.

Thus, according to the invention, a new method for the dissemination of news information, or opinion and analysis, can be seen suggesting itself, whereby once an original piece has been published and disseminated, whether as a news, feature, or persuasion piece, the piece can easily and interestingly, and even progressively, be modified to become in its successive new versions its own “folo.”

Further under this method, it can be that the publisher can maintain a “formally hostile” independent reporting and editing team whose role can be even to “adversely re-investigate” works published in the company's main news organ, as need be to rectify errors appearing in the original imprint. At the publisher's discretion, such a function can instead be performed by individuals or corporations unaffiliated with the publisher. Where the “adversive function” is performed by an organ owned by the publisher of the main publication, that main publication can be published as a “loss leader” while it can be anticipated that its adversive twin, though being published on a less frequent and irregular basis, will through per-page charges or other means such as ones that are dictated under the invention bring in the lion's share of revenue to the publisher, allowing both organs to remain economically afloat.

According to another aspect of the invention, an author intending to create a “complexed interleaved document” can start out with some finished document that has been produced by others for another purpose, and by allowing this original document to grow into a far more complex ultimate work, generate from this original a work of deeper and more general interest.

For example, the original work, such as a letter submitted to an individual or a report submitted to a public agency or division of a business, can have been some narrowly targeted work intended to be read only by one or a few individuals all of whom have expert training or knowledge and/or a high individual and professional interest in the matter discussed. For example, the original work can be a report that had been submitted to a detective squad by an eyewitness to a crime, or can be a research proposal that had been submitted to a university department head by some individual not affiliated with that school.

Preferably the original work and then the interleaves pertaining to it in the complexed interleaved document, whether the latter are composed by the same individual or some other author, will have been composed at different times and with some “space of time” between the respective acts of authoring. The author of the second, complexed work can have as his point of departure something as simple as a one-page letter or as complicated as a multi-page, multi-chapter report. The first document can be a paper document or can be an electronic document including an interleaved document, but can also be “virtual” in the limited semantic sense that it never was distributed to its target audience and perhaps it never was finished.

Such a complexed interleaved document can be created through the addition of one or more differentially-targeted interleaf sets or “channels,” preferably these to be viewed after the user has examined the first simple document as this will be present elsewhere in the complete complexed interleaved document. According to an exemplary implementation, one such channel can be intended for use by and be targeted to ordinary interested laymen, while another channel or other channels can be targeted to highly trained individuals or specialists—particularly in the latter case, those who while trained in the same subject matter as the members of the target audience of the original work, were not among that particular population and therefore do not possess some background detail that the author of the original work had expected.

According to an implementation where one “channel” of the complexed interleaved work will be targeted to laymen while another or others will be pitched at men and women with higher levels of expertise, optimally it can be that some in the layman's group, after they have examined the layman channel, will assiduously attempt to educate themselves through consulting textbooks or Internet sources, before returning to the layman's version and maybe proceeding to other, more advanced versions in other channels.

In a case in which any complexed interleaved work has been implemented with two or more interleaf channels, strings in the text file of the document can be written so as to be “in register,” in other words so that if a user chooses, while reading or rereading any version, he can toggle between the same page of various comparable versions by pressing a certain pair of action keys, programmed to permit this in the program file of the work.

There still would be alternate similar versions of the content, but rather than these being made “toggle-able” through creation of a “jump forward” and “jump back” by a certain number of strings action keys, in the program file there would be created a new type of action key that could open a second version of the document in a new browser window, starting at a string number that would be, in a preferred implementation, below the current string number by one or more strings, with provision made in the program file that no other action key be able to be used to cross into this section of the text file.

In the program file new code would open the secondary version in the new browser window in such a way that the user would, when consuming content through using the regular advance action key, (1) be charged in the same way that he would have been if using it to consume content in the original browser window, and (2) be unable, by the method of the invention as elsewhere described, to use any special action key in the new browser window to escape assessment of charges.

An unauthorized user could be able to make sense of the computer language, such as scripting programming language such as JavaScript® in which the program file has been encoded, and thereby might be able, given sufficient time and interest, to team the “combination” or combinations that had been employed by the author to block unwanted use, and to learn the meaning of each of the action keys that govern the presentation of content by the program file, after he had opened the source code of the conjoint document file using an ordinary browser. Such unwanted use of a complexed interleaved document can be more effectively blocked through the use of other aspect of the invention described herein, such as by creating a “modified document file” (that is, an .N11 document) that can be read only in a “modified browser” (that is, a B′ browser), the .N11 document which in turn can be stored only on a registered portable storage device operating in connection with a proprietary operating system, the B′ browser which in turn includes a modified word processor, and so on. Alternatively, a comprehensive approach to blocking unwanted reader use can be one involving breaking the “standard” interleaved document file into its two constituent parts, modifying the program file component accordingly, and making just the program file inaccessible to internet users, such as by making it a server-side program.

According to an alternative implementation of this method, modified document files can be created by an author to be viewed by users only through the use of a modified browser encompassing a modified word processor, all as previously described; yet instead of a modified portable storage device being employed to store the modified document files, modified document files can be stored remotely and accessible online, in a preferred implementation in an online-accessible database maintained by the publisher, particularly in a password-protected account the password of which can be designated by the user, or in an account that is otherwise protected against unauthorized access. Either the original version of a document file or an altered version of such as created by the user according to the method of the invention can be so stored, so when an altered version is created, the altered text file replaces the original text file.

When the foregoing implementation is employed by a publisher, provision can be made by the publisher restricting the use of any document by the user, for instance so that any document stored on the publisher's database can be designated for use only on a particular electronic device such as a computer the MAC address of which has been registered for use of this document by the publisher, or otherwise on multiple, similarly registered electronic devices according to a licensing scheme dictated by the publisher.

By such means, for example a publisher can allow libraries and teachers to restrict the use of a document to such users as are intended by them; however, also, it can allow governmental agencies, NGO's, businesses, or individuals to curtail the inappropriate use of an electronic document regarded by them as sensitive.

Where a publisher utilizes registered portable storage devices to store .N11 documents as a means of curtailing the inappropriate utilization of .N11 documents, special “tandemed” registered portable storage devices can be created to store such documents—the modified operating .exe of each such tandemed drive modified so as to make the .N11 materials that are stored on it viewable only on a “listed” device or “listed” devices, each having, in the case of a computer, for example, a MAC address that is indicated in the modified operating .exe of the tandemed registered portable storage device before such portable storage device had been issued by the publisher. To disseminate .N11 materials in such a case, as a non-limiting example the publisher can “pre-load” one or more tandemed registered portable storage devices with one or more than one .N11 document. Both the Web approach and the tandemed registered portable storage device approach to limiting use of .N11 documents only to “pre-listed” electronic devices can be employed by a publisher, either for different .N11 documents or for the same .N11 document.

In a preferred implementation, distribution of .N11 documents by a publisher can be automated and/or tailored to each individual registered user. For example, for each registered user a publicly accessible “sub-website” can be set up by the publisher through a server-side computer program. Then for each registered user, a website such as http://weppages.com/ 1c95Cu .htm can be created, where the code such as the foregoing fictive html document name will be unique and specific.

On each registered user's sub-site all of the .N11 titles that will be offered to him or her at any time will be enumerated in the form of hyperlinks, with or without additional information being offered, at the publisher's discretion. All copies of the same original document that will be offered to individual different registered users by the publisher will be identical, excepting that each will have been modified by the server-side computer program to embrace the respective user's unique time-code, as this can, for example, have been assigned to that user at the time of his account and sub-site's creation.

In this preferred implementation, whenever the respective registered user—or potentially any user, including ones who do not know the registered users unique time-code—will open an .N11 document by clicking on a link on the user's sub-page, that individual will be able to view without cost or inputting any time-code, a fixed unit of content, such as one screen or an incomplete set of “public screens”—this one screen or incomplete group of screens viewable only within a browser window of the proprietary B′ browser, and only if a registered portable storage device is presently inserted in the user's computing device.

Then, once the user's unique time-code has been entered, a copy of an executable file representing the entire complete .N11 document will be downloaded to the registered portable storage device that the user has emplaced in the computing device, while simultaneously—if such is the publisher's preference—a fee can be assessed of the user according to an executable program that has been made to be present on the registered portable storage device by the publisher either at the time of the portable storage device's creation or at the time of the .N11 document's downloading from the publisher's server, this latter executable capable of communicating with the publisher's server to permit the assessment of fees.

Even though the text file of each such .N11 document will be viewable by the user employing the modified, proprietary B′ browser as discussed elsewhere herein, a document's program file—in this implementation, the program file physically separate from the text file and preferably authored through the use of a different computer language than the JavaScript® or other scripting programming language of the text file—will be made never viewable by any user, preferably because it will be an executable file, in order that the time-code will not be viewable by an unintended public user.

According to an alternative aspect of the invention, where according to a previously-described aspect of the invention a user has created his or her own modified, “commenting” version of an original .N11 document, that user can independently offer this modified version of the original .N11 document for sale on the publisher's website—either automatically or after a review of the modifications by the publisher—and either to certain other of the publisher's registered users or to all of its registered users—by the publisher through its use of a server-side computer program to allow such to be accomplished, that then through the posting of a link to such “secondary” commented documents on individual users' sub-sites.

Such a server-side program can, for instance at the time of the downloading of such a modified .N11 document by a user, replace the original time-code with a new time-code correct for the second user within the .N11 document's program file.

Using a similar server-side program, the publisher can allow a user who wishes to loan, give, or sell his or her own copy of an .N11 document (whether as modified by this initial user or not) to some second registered user, to upload that document to the second registered users sub-webpage, so at once when the second user is offered the .N11, the first user's access to it will be lost for an indefinite time through deletion or modification of, in the sense in the latter case of preventing the use of, the .N11 document as housed on the first user's portable storage device.

In such a case, if the first user decides to revoke use of the .N11 document by the expected second user, the first user may through using the publisher's server-side program at any time-point until the expected second user has clicked on the link in his or her sub-page, eliminate this hyperlink on the second user's sub-page and regain the usability of his or her .N11 document on his or her registered portable storage device.

According to another aspect of the invention, the identity of any or all action keys can be, through use of ordinary CSS formatting options by the author, made inapparent to the viewer until the viewer has highlighted the screen, such as on a PC by pressing the “alt” and “A” keys together—this by the author through use of CSS formatting options making the color of the text that represents the action keys similar to the background color of the page, for example.

At the author's discretion, the displaying of the source code merely of the “first freely available portions” of an electric-book document whose later portions will be available as an .N11 document after payment or entry of a time-code, or both, can be blocked. In a preferred implementation, the displaying of the source code of the free, public portions can be blocked through use of a computer language such as C, Ruby on Rails, Python, or some other network-compatible computer program that does not allow source code to be viewed in the coding of the first freely available portions of the document only. At the author's discretion, when a user is acquiring the complete .N11 document, for instance from his sub-site on the publisher's website, the source code of the initial free portions can be made available at the same time as the source code of the remainder of the .N11 document for instance through a re-coding and duplication of those free portions, now as parts of the complete .N11 document as available for download.

According to another aspect of the invention, a publisher can enable a user who is viewing the free initial portion of a complete .N11 document in a B′ browser window to download the complete .N11 document and its associated executable files at any time while reading the free document, once the time-code corresponding to the present sub-site of the publisher's website has been entered. According to the invention, the download will be stored to a registered portable storage device that is present in the viewing device. Permission to download can be limited through a further requirement that only a certain registered portable storage device—for instance one registered by the publisher when the respective sub-page had been set up—or one among several registered portable storage devices—be present. At download, fees as indicated by the publisher can be assessed, and other fees can be assessed later according to the method of the invention.

According to another aspect of the invention, an ordinary, commercially available portable storage device already in the possession of a user can be converted to a registered portable storage device, first through registration of the portable storage device's container ID with the publisher, and second, through the addition of executable files as required for the correct functioning of a registered portable storage device to that portable storage device—both occurring when the user's viewing device is displaying in a B′ browser window a “registered portable storage device set-up window” on the publisher's website and while the initially unregistered portable storage device is present in or otherwise coupled for communication with the viewing device. Provision of information such as an email address, credit card number, personal security information, a user-selected PIN, and/or other identification/authentication information can be required by the publisher for registration. At registration, which can be free to the user or not, the assignment of a unique sub-window code and respective time-code can be made by the publisher.

At the publisher's option, the time-code corresponding to a particular publisher's sub-site can be made changeable after identifying information and/or answers to questions as pre-selected by the user, for example, are provided by a user. Changing a time-code can require interaction with a representative of the publisher or be accomplished without human interaction, by way of an automatic server-side program that is maintained by the publisher, for instance.

According to an another aspect of the invention, after the user has entered the correct time-code while viewing an .N11 document, or while viewing the initial free portion of a document, he can automatically be presented with a sound file or a video, whether this is a commentary by the author or editor (or a later commenter), or recorded audio or video footage from an interview, for example. Whether provision of this to the viewer will be accompanied by assessment of a fee can be established at the publisher's discretion.

According to an another aspect of the invention, in the case of an .N11 document, a tag embracing the respective sound or video file can be emplaced in a string within the text file at a different location than the current location, while a portion of the program file will direct the CPU to shift its reading frame to summon that string to play the sound or video file embodied therein once the time-code has been entered. In one implementation, the request for the time code can be emplaced within a user prompt. In a separate implementation, according to code that is part of the program file, the reading frame can be automatically returned to the original location after the sound or video file has been played, or it can be returned once the user has activated a designated action key, for instance a certain standard “return key” such as the Enter key.

In the case of the free initial portion of a document, implementation of this method may vary substantially from the approach described herein, or not. As extreme examples, the free portion of a document can comprise a single electronic image, or multiple electronic images on multiple sequential pages, with or without tag lines.

Once a certain .N11 document has been obtained by a user, at the publisher's discretion the user can no longer be required to enter his particular unique and complex time-code every time he wishes to obtain material according to this method; instead, he can be permitted to enter an abbreviated, simplified time code that no longer need be uniquely his—one which can have been derived from the users original time code and assigned automatically by a server-side program that is maintained by the publisher, or can be a new code chosen by this user “because it will be easy to remember,” and for no other reason, as non-limiting examples.

At the publisher's preference, during viewing of the first free portion of an .N11 document, at the time of the downloading of the complete .N11 document by the user, initial fees as dictated by the publisher can be assessed, and other fees can be assessed subsequently for use of this .N11 according to the method of the invention.

At the publisher's preference, it can be made impossible for users to edit the first free portion of a complete .N11 document unless and until they have downloaded the complete .N11 document, through means that will be apparent to one skilled in the art.

If the author chooses to allow this to be done, a certain modified time code can be entered by a user whenever he wishes to print the current page from a connected printer—the modification being for example entry of the letter “p” by typing, immediately after the user's time code (or simplified time code) has been entered.

According to an another aspect of the invention, a file as represented on a publisher's website or sub-site can be designated by the author as “complete” or not depending on a naming convention. For example, a subtle change in the file name, such as from “_filename,-.htm” to “_filename_.htm” can indicate in the first case that the document is preliminary, and in the second case that the file is “complete” (even though later changes could be made). Similarly, while “[a recent date x]._filename_.htm” can indicate the current copy of a file on a publisher's website or sub-site, “[an earlier date y]._filename_.html” can indicate an earlier version that is still available through the publisher's website.

In order to keep portions of an interleaved document “relatively outside” the public domain, that is, to make the consumption of it in its entirety, or consumption even only of a certain subsection or subsections of it relatively difficult except by members of a by-the-author-designated target group, prior to publication even if it will be published openly in a simple URL online, the author can form it into a sort of a “puzzle box” of a high level of complexity.

Such “puzzle box development” can be accomplished by the author of a “standard” interleaved document, that is, not an .N11 interleaved document, very simply for example by not publishing on its first static page that will be presented to readers, and simultaneously by not offering in a “transmission email” which includes a link to the URL of the interleaved document, instructions explaining how this document is ideally to be used—meaning, which action keys are “active” and what they do, and/or at what point or points during the user's progression through the complicated document they are optimally to be pressed. In this case instead, suitably complicated instructions for using the document can be distributed by the publisher to a by-the-author-designated closed mailing list only, such as by text message—so solely these (initially) can easily unlock the puzzle box and navigate the document in order string-by-string.

To make an entire document, or to make a particular section or sections of it much more difficult to access, in a like way—by not “broadcasting” the instructions to a “standard” interleaved document which will be published in a simple URL online, and instead narrow-casting the instructions to a closed mailing list of trusted users—in this case additionally the author can within the document deliberately “hide” especially sensitive or perhaps only arcane and obscure sections of content by making them not available for presentation within the browser window other than to users who first had activated a complicated and specific-to-this-section “redirect action key ‘combination’” in correct order. When applying this approach, the author can ideally modify the text file of the document before publication in such a way that each correct redirect action key activation within the combination will lead the user to a “next screen” that appears to be identical to, and may be identical to, the prior screen arrived at; so users who are applying a valid redirect action key combination cannot have the least sense that “they are on the right track” until the first page of the sought-after content opens up before them. To make such a section still more difficult for “undesired” users to take in, the author can make its first page indeed a page that will include an action-key list similar to the one described in the prior paragraph, however which in this case will be “peculiar” to this first section of the document, so the action-key instruction list will be purposeless for users to apply to other sections of the text file.

When this aspect of the invention is practiced, accompanying the text message sent to trusted users with instructions that describes in detail correct use of the “standard” interleaved document can be a text message describing the limited “time window” during which the respective interleaved document must be downloaded in order so that the “combination” or various combinations and/or the respective “action-key set” can correctly be used with the respective document; for after that interval, the document especially in its “navigation approach” will be changed by the publisher.

To limit unwanted access across a group of documents published according to this aspect of the invention, the document referenced in the foregoing description can be a table of contents.

All of the foregoing measures of unwanted-reader “protection” can be achieved by an author through suitably modifying the program file of the respective “standard” interleaved document—that is to say, an interleaved document that can be viewed in ordinary Web browsers and furthermore that is unitary, so that the program file and text file of the document file are not broken apart with only the former's code accessible to viewers through activating the respective Web browsers view source-code function—by designating specific skip-ahead or -behind action keys and any other requisite action keys within the program file of the document file, as discussed elsewhere herein, while furthermore limiting certain of these action keys to function only when the current string number is a certain string number or within a certain range of string numbers.

According to another aspect of the invention, it is possible to “interlink” from a single mention of a term in a chapter, such as in a textbook, to all other mentions of this term in the same book and in other books produced by the same publisher or by different publishers, by agreement between them.

That is, in an interleaved electronic book, as discussed elsewhere herein, there can be placed before every main page, one pair of or several interleaves, the content of which can be identical to the main page from which they descend, other than in that they can be hyperlinked. One such interleaf page can bear links to other citations of the same word in the same book, while another or others can bear links to another book or other books, or to other hyperlink webpages complexly bearing links to the same term in multiple books.

Hyperlinking words or phrases differentially, even copiously, for example with different portions of a phrase or sentence leading in different directions and to different links, can be done if the author instead of utilizing a single hyperlink color scheme for the entire web document, utilizes different colors for each of the links or many of the links drawing out of a certain sentence by dictating the text color of a hyperlink unchangeably through using a <font color=‘#______’> tag or other tag prior to the hyperlink, at the same time eschewing the usual “hovering” color change. That this is rarely done by Internet authors today largely stems from the fact that the ensuing text would be challengingly cluttered and hard to read—not a concern if as here, the hyperlinks are all on a second page—in this case an interleaf page having text that is identical or essentially identical to that of the first.

Each special interleaf hyperlink page can bear a series of listings—each a link—at its top a heading including the indexed word or phrase, and below that, brief summaries of every reference—each including a summary of the reference along with thumbnail representations of the section's figures, and at the end of each, additional data, for instance the title of the chapter in which the reference lies, the reference's length in words, sentences, and paragraphs, for instance, along with the length of the chapter in which the term is imbedded if desired.

Depending on the reader's level of interest, he or she can link to many of the referred-to sections in turn, or otherwise, if it is believed by the user that the summaries themselves satisfied his needs, return to the main article from which he had departed (at the same “line height” on the page whence he had departed, if suitable modifications in the program file of the document have been made) by pressing the string-at-a-time “forward” or “backward” action key of the document the correct number of times, or by performing any previously designated action.

If a publisher decides to link an electronic work published under this invention to multiple other such works published by the same publisher, this goal can be straightforwardly accomplished through the publisher's increasing the number of interleaves per main page by increasing the “skip number” in the program file of the work to as great a number as is necessary from this perspective. So that users may easily “cross-access” all of the listed books, it is preferable that they be owned by this individual and all be stored on the same portable storage device, or alternatively, if this user is viewing the content of a library, that all those works be in the collection of the library.

According to the invention, fees charged to viewers for their consumption of units of material can be thought of as falling into two discrete classes: one stemming from user actions in which the user will always be charged, regardless of whether this act occurs when the string that is being viewed is a main string or is some other string, and regardless of whether the viewer may have rendered fee delimiters and all other delimiters meaningless through a prior deliberate act or series of acts, for instance, a series culminating in the viewer's advancing string-by-string through every string from a certain point forward; and on the other hand those actions that will be assessed for only as the viewer is normally skipping interleaf strings to view only main strings successively while pressing the main forward action key. (Those of the latter class are further divisible into two types, ones that involve the viewer's passing a true fee delimiter, and others that stem from some other assessable act such as passing the end of a string.)

While charging for the former class under this invention can be quite straightforward and can be vastly simpler to program for than programming for the other type of charges, in most circumstances charging for the simpler class will be less desirable from the users perspective and so from the publishers.

And while charging for fees in the latter class can be straightforward in one very limited case—when the publisher has eschewed permitting users to alter their own copy of a document—in general terms charging for that class will not be straightforward, for the reason that without further modifications in a document's program file being made to block this from happening, an unscrupulous user can copy up to every main string that embraces fee instantiations and replace them elsewhere in the text file where they will only be seen by the CPU as interleaves—and otherwise an unscrupulous user can duplicate fee delimiter-bearing strings anywhere within the text file, yet now with the fee instantiations removed to be able to avoid being assessed fees for the consumption of material.

According to one implementation, by the author to block users from employing either of these nefarious “get-arounds”:

First, the word processor of the modified browser can be modified in further ways: (1) so that whereas each main string can be numbered sequentially, for instance at the time of the document's final electronic setting, although these string numbers will be able to be copied into and then viewed in the modified word processor window as a component of the initial documents source file, those numbers will be forever inalterable and so cannot occur anywhere where the pertinent string has been copied except identically as in the original document; (2) so that fee delimiters that are in a similar way numbered, will not be permitted to be altered in any way or removed from or moved within the string where they had originally occurred upon having been copied into the modified word processor, so therefore similar to element (1), these fee delimiters whenever copied will continue to bear the same identifying number and not be changed otherwise, for example in the amount of the fee, (3) no main string can be copied within the word processor other than to another location as again a main string, and (4) as necessary in the program file circumscribing the use of some action keys, so that the only way that copied main strings could be accessed if these occurred “beyond their normal range” would be by pressing the ordinary advance key. (For instance such could be done by defining a strip of strings at the end of the original text file as a “dead zone,” in which the “advance one string at a time” key could not be used.)

Second, the program file can be modified so that both types of identifying numbers discussed in the previous paragraph will not be rendered in the browser window when the respective string is displayed by the CPU, yet still can have meaning to the CPU.

Third—as an approach to prevent viewers from being charged more than once for exposure to a particular numbered fee delimiter where such has been duplicated by a user within an .N11 document—the program file of the modified document file and the .exe file that is distributed by the publisher whenever a modified document file is distributed can conjointly be modified so that the latter can in part comprise a “fee instantiation register” which will record the first use of a particular numbered fee delimiter wherever and whenever deployed in an altered document. Under this provision, the .exe need never be modified while the respective .N11 is being viewed by a user except so that the first time that any delimiter is used, such use can be reflected for instance through some pre-defined modification of the fee delimiter number in the fee instantiation register, as for instance the addition of a certain letter such as an “A” at the end of such number to designate its use.

Subordinately, simultaneously the word processor can be modified so that when a user utilizes it to view the text file of an .N11, whether this is the original version of it or a user-altered copy of it, the user can see instantly for instance through a change in the color of the fee delimiter and/or its identifying number, whether it has already been read and assessed for in this user-modified copy of the .N11 document.

Thus, users who alter their own copy of an .N11 document, but also users who utilize a copy of an .N11 document that has been altered by another user (in the latter case, that has been made available via the publisher's website, as discussed elsewhere herein), will not through making such a copy be able to remove, bypass, or make changes to any useful fee delimiter; and likewise, in any copy that is made, users will not be able to remove, bypass, or make changes to any useful fee delimiter.

Furthermore, no matter how many times a string bearing a fee delimiter is reproduced by a user in making an altered version of an .N11 document, and no matter how many times a particular delimiter or copy of it is passed by the user during use of an .N11 document or altered .N11 document, such user will never be charged more than once for use of the delimiter.

Also, because use of delimiters will be recorded in the fee instantiation register consisting of the .exe file that is stored on the same registered portable storage device as is used to store the .N11 document itself (both being transferred together whenever the moving of the .N11 document to a different portable storage device is desired), should a user ever wish to obtain a partial refund for the incomplete consumption of an .N11 document from its publisher, this will be straightforward, in that when the .exe file is returned to its publisher, the publishers server can easily determine the amount of the refund based partially in this occasion on the extent of the field of the .N11 document's fee delimiters' use.

According to another aspect of the invention, a variable “multiple time delimiter” to be used as a time code to track and control all forms of access to an .N11 document. For example, a “double time delimiter” can be utilized by an author. Such a delimiter, coded for in the program file of an .N11 document, can be, for example, of the form “_{— —}(x)_(y)_” (space, space, variable numeral, space, variable numeral, space) and preferably used where the viewing device used by the user will be a computer or some other device with a communicatively attached keyboard.

Each of the above variables can be a time interval measured in, for example, tenths of a second, and will dictate, in the case of the first, the duration of an interval during which depression of no keyboard keys will be able to be sensed by the user's CPU, and in the case of the second, the duration of a “receptive pause” immediately after the first interval during which any single key can be sensed, yet after which no key will be able to be sensed if a specific key as designated by the author in the program file of the document file has not been correctly struck first.

The purpose of such double time delimiter will be to enable publishers to assign a unique and presumptively uncrackable multi-key “time-code” to each of its registered users—advantageous to the publisher for various reasons discussed below.

A publisher employing this system can also in an executable file governing operation of the .N11 document by users—specifically, an executable file including the program file—cause the MAC number or other similar unique code number of the users computing device to be recorded at the time that the .N11 document had been downloaded to the user's registered portable storage device that will be present in his computing device, and then if subsequently a predefined number of incorrect keystrokes are entered during a single receptive pause or a plurality of receptive pauses, “lock out” this device, thereby preventing it from displaying this .N11 document or all of the publisher's .N11 documents permanently or temporarily (such as until the publisher has been contacted by the user and the cause of the error satisfactorily explained), or otherwise restrict access from this device to this .N11 document and/or any other of the publisher's .N11 documents for any length of time as specified by the publisher.

Downloaded at the same time as the .N11 document itself preferably will be a “delimiter use register,” which will be an executable file—as discussed elsewhere herein. Both this executable file and all other executable files that are emplaced on the registered portable storage device by the publisher will be able as necessary to capture reader keystrokes while simultaneously capturing the location in the text file at which the CPU will be reading when the user strikes a key.

Once the complete .N11 is present on the users registered portable storage device, at various particular points during presentation of the document the same users unique time-code can be requested, that is, whenever a “time-code-requesting delimiter” such as _{— —}*_(z)_(space, space, asterisk, space, variable numeral, space) has been emplaced in the text file by the author.

At this point, if and only if the correct time-code had again been inputted by the user, in a separate B′ browser window additional material—whether comprising a further portion of the “main document” or comprising “commenting” interleaf material dictated by the author—can be made to appear, possibly with the concomitant assessment of a fee as represented by the (z) variable when this is not zero. Then the further utilization of the new material by the user will be monitored by the respective executable files on the user's portable storage device so that fees can be assessed for use of this portion of the overall document as appropriate and in ways discussed elsewhere herein.

Therefore according to this embodiment, according to the publisher's preference, an .N11 document or a set of such can be downloaded by the user free of charge, or can occur concomitantly with the assessment of a fee whether this fee will be simple or complex, as is discussed elsewhere herein; yet in both of these cases cost to the user can be augmented variably according to the value of the (z) variable present in the respective time-code requesting delimiter before the user will see the additional material, in addition to being augmented in other ways as discussed herein if such is the author's preference.

As a precaution against the inappropriate reading, publicizing of the contents of, and/or publication of an .N11 document for example after the registered portable storage device on which the document had been stored has been lost by a user, an author through modification of the program file of an .N11 document prior to publication can enable users (themselves) to demand that their own personal time-code or simplified time-code, or another time-code that has been specifically selected for this document by the user, be entered before the document can be re-opened after having been closed once this option has been activated by a user. In an alternative implementation, this requirement can be mandated of all users by an author or a publisher; in such case, all users will be required to enter their own personal time-code every time they wish to re-open the document.

A modified time-code requesting delimiter can be employed to redirect the current reading frame to a string where particular content is located. A delimiter of the form, “_{— —}*_(z)_(n)_”, as one example, where (z) as previously indicated will be a variable number setting the cost to the user of entering the time-delimiter, can through the variable number (n) dictate the “target sting” to which the CPU will be redirected when the time-code has been correctly entered.

If a target string is a main string, the target string can include other delimiters, including fee delimiters and other, now-secondary modified time-code requesting delimiters. In the target string, and in nearby strings, whether these are main strings or interleaf strings, there can be text and other types of content including charts, graphs, graphics, and multi-media presentation modules such as Adobe® Flash® modules, as non-limiting examples.

For example, in case of the above, as a means of increasing the number of action keys that can be utilized within a screen or throughout a document, the author can create the program file of an .N11 document so that one or more individual action keys will produce different actions depending on the string number of the string that is being read by the CPU when the action key is struck and/or the location of the user on a page at the time the action key is struck. In a preferred implementation, the respective portions of the program code will involve demanding a match, either exactly or within a range, of one or more current-location variables such as string number, line height, and mouse location, as non-limiting examples.

If an author codes for in the program file an action key or modified time-code summoning delimiter, either of which when put into action by the user will redirect the CPU to a physically isolated section of the text file, the author can prevent the user from “crossing out of” that section by various measures, for example through establishing in the program file both positive and negative “tethering” variables specific to that particular isolated region of the text file, these which will limit the number of strings from an entry string by which the string number can increase or decrease, ultimately, unless the isolated region is exited by the user.

A limitation of the current invention is that delimiters except where these appear in main strings will be unable to be read meaningfully by the CPU. Although this is a limitation, it actually has a silver lining; for it leads to a situation in which costless interleaves can especially be employed to enhance, augment, qualify, and/or refine the author's meaning and the message of the main strings that these interleaves precede or follow.

Where a “highly complex interleaved document” constituting a simple modified document file or an .N11 document, and consisting of a number of rather unrelated salients of narration, explanation, or analysis (authored for different reasons at different times, for example) has been made deliberately difficult to use, such as by being published without a “correct order” for the respective parts being dictated to users—or even by the author taking pains to “bury” units of content so these will never automatically be displayed except after the document has been suitably modified by a user to allow this (as a non-limiting example, through the user's moving a “buried” string within the text file in order to allow some previously programmed action key to point to it)—it can be the case, more frequently than is the case now when ordinary paper “modern” documents are read, that careful users of a complex interleaved document can experience something akin to the author's own individual and personal process of discovery, even up to arriving at something akin to his or her own “Eureka” moments.

Where such an approach is employed, although one or more “basic channels” of content can be made available free of charge or inexpensively to users of the .N11 document file, a secondary heuristic channel or secondary heuristic channels that are intended to explain the content to less sophisticated or highly trained users can be made available as well, the use of these, though, being made more expensive according to any of a number of schemes, apparent to one skilled in the art. Thus it can be expected that before pressing the designated action key to enter such a secondary heuristic channel, many readers will stop to ask themselves if there might be some way that they could reach a better understanding of the material without paying for it—like reading the material more carefully and slowly again, or going online to search for other free, pertinent sources of information, for instance. Simply the fact that such users would have to have stopped to think can be helpful toward the end of allowing the individual to find his or her own personal path to intellectual discovery—whether this process would bring the users to the actual same points of understanding as the author had, being a matter of indifference to the author, possibly.

Particular exemplary embodiments of the present invention have been described in detail. These exemplary embodiments are illustrative of the inventive concept recited in the appended claims, and are not limiting of the scope or spirit of the invention as contemplated by the inventor.

I claim:

1. A method of governing content presentation of multi-page electronic documents, comprising:
providing, to a publisher, a document file, wherein the document file includes a program file, and a text file functionally associated with the program file;
providing, by the publisher to an author, at least the text file;
creating, by the author, at least one version of a work of content based on the at least the text file, wherein the at least one version includes a current version, wherein the current version is parsed into defined units of content;
providing, by the author, the units of content of at least the current version of the work of content to a user, to be viewed by the user on a display device in a sequence determined by the author;
wherein creating the at least one version of the work of content includes arranging the work of content such that at least one of a predefined action and a predefined condition causes at least one of
redirection of the viewing of the content from a current unit of content of the current version to a different unit of content of the current version, regardless of the sequence,
at least one of revealing to the user previously unviewable units of content and concealing from the user a currently viewable unit of content,
at least one of addition of a subsequent unit of content and removal of a current unit of content,
replacement of at least one unit of the current content by a subsequent unit of content, and
replacement of the current version with a subsequent version.

2. The method of claim 1, wherein the text file is an empty text file.

3. The method of claim 1, further comprising:
creating, by the author, one or more channels of subsequent content, wherein each said channel of subsequent content includes one or more versions of subsequent units of content;
associating, by the author, different ones of said channels of subsequent content with respective classifications of users; and
arranging the work of content provided to a user having a classification such that at least one of a predefined action and a predefined condition causes addition of at least one unit of content from the channel associated with the user's classification to the current unit of content provided to the user.

4. The method of claim 3, wherein the versions of subsequent units of content are sequential.

5. The method of claim 3, wherein the versions of subsequent units of content are non-sequential.

6. The method of claim 1, further comprising restricting access of the program file by the user.

7. The method of claim 1, further comprising denying to the user access to the program file.

8. The method of claim 1, further comprising selectively denying to the user access to at least portions of the program file.

9. The method of claim 1, further comprising:
modifying, by the user, the text file, to produce a modified text file;
storing the modified text file only at at least one of a server and a node controlled by the publisher; and
restricting, by the publisher, access to the stored modified text file.

10. The method of claim 1, wherein providing, by the author, the units of content of at least the current version of the work of content to a user, includes providing the units of content on a first portable memory device registered for use only with one or more authorized reading devices, the method further comprising:
modifying, by the user on an authorized user reading device, the text file, to produce a modified text file;
storing the modified text file only on one of the first portable memory device and a second portable memory device, wherein the second portable memory device is registered for use only with one or more authorized reading devices including the authorized user reading device, wherein the second portable memory device is associated by the publisher with the first portable memory device; and
restricting, by the publisher, access to the stored modified text file.

11. The method of claim 1, further comprising granting, by a publisher, access to a user website to the user;
wherein providing, by the author, the units of content of at least the current version of the work of content to a user includes making available the units of content to the user at the user website.

12. The method of claim 11, further comprising:
requesting, by the user, access to the units of content at the user website;
allowing the units of content to be stored on a storage device coupled for communication with the display device;
after the units of content have been stored on the storage device, providing fewer than all of the units of content to the user;
providing, by the user, a user code;
evaluating, by the publisher, the user code;
providing additional units of content to the user if the user code is valid; and
denying access to the additional units of content to the user if the user code is not valid.

13. The method of claim 12, wherein providing additional units of content to the user includes accessing the additional units of content for display on the display device.

14. The method of claim 1, further comprising:
modifying, by the user, the text file, to produce a modified text file;
storing the modified text file only at a server controlled by the publisher; and
providing, to another user, access to the stored modified text file.

15. The method of claim 14, further comprising charging a fee to the another user prior to providing access to the stored modified text file.

16. The method of claim 1, further comprising:
modifying at least the text file such that a background is a background color; and
modifying at least the text file such that text is a text color that is substantially similar to the background color.

17. The method of claim 1, wherein providing, by the author, the units of content of at least the current version of the work of content to a user includes providing initial units of content to the user, the method further comprising:
providing, by the user, a user code;
evaluating, by the publisher, the user code;
evaluating, by the publisher, a device code associated with a portable memory device coupled for communication with the display device;
storing additional units of content on the portable memory device if the user code and the device code are both valid;
charging a fee to the user prior to storing the additional units of content; and
denying access to the additional units of content to the user if the user code is not valid.

18. The method of claim 17, wherein
storing additional units of content on the portable memory device includes storing the additional units of content by use of a modified web browser authorized by, and registered with, the publisher, only if a browser code associated with the web browser is validated by the publisher, and
denying access to the additional units of content to the user includes denying access if the browser code is not validated.

19. The method of claim 17, further comprising registering the portable memory device, comprising:
registering the device code with the publisher; and
storing, by the publisher, an executable file on the portable memory device, wherein the executable file is designed to communicate with the publisher and with the display device to control presentation of the content on the display device.

20. The method of claim 17, further comprising:
providing, by the user, at least one of identifying information and an answer to a question; and
changing, by the publisher, the user code in response to receipt of the at least one of the identifying information and the answer to the question.

21. The method of claim 1, wherein the units of content include at least one of a sound file and a video file.

22. The method of claim 21, wherein the text file includes at least one tag, the method further comprising:
when the user reaches the tag while viewing content, redirecting presentation of the content to a unit of content that includes the at least one of the sound file and the video file for presentation to the user; and
returning presentation of the content to the tag after at least one of
presentation of the at least one of the sound file and the video file for presentation to the user, and
performance, by the user, of a predetermined action.

23. The method of claim 1, wherein providing, by the author, the units of content of at least the current version of the work of content to a user includes providing initial units of content to the user for viewing in a browser widow that is registered with the publisher for use by the user, the method further comprising:
providing, by the user, a user code;
evaluating, by the publisher, the user code;
evaluating, by the publisher, a device code associated with a portable memory device coupled for communication with the display device;
storing additional units of content on the portable memory device if the user code and the device code are both valid and are both associated by the publisher with the registered browser; and
denying access to the additional units of content to the user if the user code is not valid.

24. The method of claim 23, further comprising charging a fee to the user prior to displaying the additional units of content.

25. The method of claim 23, further comprising allowing the user to modify the units of content only after storing the additional units of content on the portable memory device.

26. The method of claim 23, wherein the current version is presented in a first browser window, the method further comprising
opening a second browser window, and
presenting the subsequent version in the second browser window.

27. The method of claim 1, further comprising:
providing, by the user, a user print code;
evaluating, by the publisher, the user print code;
allowing the user to print a hard copy of the current unit of content if the user print code is valid; and
denying print access to the user if the user print code is not valid.

28. The method of claim 27, further comprising allowing the user to print a hard copy of a subsequent unit of content if the user print code is valid

29. The method of claim 1, further comprising applying a naming convention to the document file to indicate whether there is at least one of another unviewable unit of content to be revealed, another subsequent unit of content to be added, another unit of the current content to be replaced, and another subsequent version to replace the current version.

30. The method of claim 1, wherein
the author provides the work of content to the user via a first mode of communication, and
the predefined action is a plurality of predefined actions;
the method further comprising providing an explanation of the plurality of predefined actions to the user via a second mode of communication, wherein the second mode of communication is different than the first mode of communication.

31. The method of claim 30, further comprising modifying, by the author, the program file such that efficacy of the predefined action is limited to a predefined time period;
wherein the explanation of the plurality of predefined actions to the user includes a notification of the predefined time period.

32. The method of claim 30, wherein the work of content is a table of contents that includes a plurality of hyperlinks, wherein each said hyperlink provides access to the user to an associated respective further work of content.

33. The method of claim 30, wherein the work of content is a table of contents that includes a plurality of infralinks, wherein each said infralink provides access to the user to an associated respective further work of content within the current version.

34. The method of claim 30, further comprising designating the predefined actions in the program file by the author.

35. The method of claim 30, further comprising adding an overlay to the content, wherein the overlay provides information to the user related to the predefined actions.

36. The method of claim 35, wherein the overlay includes overlay content, wherein at least some of the overlay content includes hyperlinked content.

37. The method of claim 35, wherein the overlay includes overlay content, wherein the overlay content includes at least one of notes, footnotes, comments, hyperlinks, and action key information.

38. The method of claim 34, further comprising:
parsing each said unit of content into strings; and
associating at least one said predefined action with a particular designated string.

39. The method of claim 1, wherein the at least one of the predefined action and the predefined condition causes at least one of
revealing to the user previously unviewable units of content arranged between previously viewable units of content as interleaved units of content,
addition of a subsequent unit of content, arranged between current units of content as interleaved units of content,
replacement of the current version with a subsequent version, wherein the subsequent version includes units of content that were not present in the current version, arranged between units of content in the current version as interleaved units of content;
wherein each said interleaved unit of content is identical to an adjacent unit of content except that at least some text in the interleaved unit of content is hyperlinked text.

40. The method of claim 39, further comprising selecting, by the author, of a color of the hyperlinked text, individually for each item of hyperlinked text.

41. The method of claim 39, further comprising actuating an item of hyperlinked text, thereby redirecting viewing of the content by the user to a unit of content including a series of hyperlinked listings and descriptive content related to the hyperlinked text.

42. The method of claim 41, further comprising:
linking, by the publisher one said hyperlinked listing to an associated other work of content;
actuating, by the user, the one said hyperlinked listing;
allowing the user to access the associated other work of content if access is authorized by the publisher; and
denying the user to access the associated other work of content if access is not authorized by the publisher.

43. The method of claim 1, wherein the content includes hyperlinks, and wherein units of content that include hyperlinks include only hyperlinks and are separate from units of content that do not include hyperlinks.

44. The method of claim 1, wherein each said unit of content includes at least one delimiter, the method further comprising modifying a word processor interpreting the document file for presentation to the user to apply an inalterable delimiter number to each said delimiter in the work of content such that each said delimiter number is unique to the respective associated delimiter within the work of content.

45. The method of claim 44, further comprising preventing display of the delimiter numbers to the user.

46. The method of claim 45, further comprising:
counting the delimiters passed by the user while the user views units of content to provide a delimiter count;
registering the delimiter numbers of the delimiters passed by the user while the user views units of content; and
ensuring that the delimiter count is incremented only once for each registered delimiter number, regardless of a number of times the associated delimiter has been passed by the user.

47. The method of claim 46, wherein the at least one delimiter includes a plurality of delimiters of at least two delimiter types, wherein counting the delimiters includes counting delimiters of each type separately from each other.

48. The method of claim 47, further comprising
charging a fee to the user as the user views content, and
incrementing the fee as the user passes each delimiter, such that the fee is incremented differently for at least one said delimiter type.

49. The method of claim 46, further comprising presenting an indication to the user as to whether at least one of the currently-viewed unit of content and the next sequential unit of content is associated with a delimiter number that has previously been registered.

50. The method of claim 1, wherein each said unit of content includes at least one delimiter specifying a time element related to performance of the predefined action.

51. The method of claim 50, further comprising controlling, by the publisher, access to the work of content by the user based on performance of the predefined action by the user with respect to the time element.

52. The method of claim 1, wherein each said unit of content includes at least one delimiter, the method further comprising tracking and registering the delimiters passed by the user as the user views content.

53. The method of claim 52, further comprising:
installing an executable file on a portable memory device connected for communication with the display device; and
using the executable file to perform the tracking and the registering of the delimiters.

54. The method of claim 52, wherein the at least one delimiter includes a code-request, the method further comprising requesting the user to provide a code when the code-request delimiter is passed by the user as the user views content.

55. The method of claim 54, wherein the code is a time-code.

56. The method of claim 54, further comprising:
providing, by the user, a valid code in response to the request; and
providing, to the user, additional content in response to receipt of the valid code.

57. The method of claim 56, further comprising charging a fee to the user prior to providing the additional content.

58. The method of claim 56, further comprising requiring, by the publisher, provision of the valid code before providing, by the author, the units of content to the user, after access to the work of content by the user has lapsed by a predetermined period of time.

59. The method of claim 54, wherein each said unit of content includes at least one string, the method further comprising:
providing, by the user, a valid code in response to the request; and
redirecting presentation of the content to the user to a target string, in response to receipt of the valid code.

60. The method of claim 59, wherein the target string includes at least one additional delimiter.

61. The method of claim 59, wherein the valid code is a key.

62. The method of claim 59, wherein the valid code is a succession of keys.

63. The method of claim 1, wherein each said unit of content includes at least one string, the method further comprising modifying a word processor interpreting the document file for presentation to the user to apply an inalterable string number to each said string in the work of content such that each said string number is unique to the respective associated string within the work of content.

64. The method of claim 63, further comprising preventing display of the string numbers to the user.

65. The method of claim 1, wherein each said unit of content includes at least one string, the method further comprising changing the predetermined action based on the particular string of content being viewed by the user.

66. The method of claim 1, wherein each said unit of content includes at least one string, the method further comprising limiting, through function of the program file, an extent of redirection of the viewing of the content from the current unit of content to the different unit of content of the current version.

67. The method of claim 66, wherein the extent of redirection is measured in a number of strings.
